(19) United States
(12) Patent Application Publication
(10) Pub. No.: US 2018/0320630 A1
(43) Pub. Date: Nov. 8, 2018

(54) Internal Combustion Engine Cylinder Head with Tubular Apparatus for Intake and Exhaust

(71) Applicant: XIACAMERI, Windsor (CA)

(72) Inventors: Zhouxuan Xia, Windsor, Ontario (CA); Yisheng Cui, Pleasanton, CA (US); Chunguang Xia, Pleasanton, CA (US)

(21) Appl. No.: 15/916,770

(22) Filed: Mar. 9, 2018

Related U.S. Application Data
(60) Provisional application No. 62/501,403, filed on May 4, 2017.

(30) Foreign Application Priority Data
Aug. 4, 2017 (CN) 201710661831.7

(51) Int. Cl. F02F 1/42; F02F 11/00; F02F 1/24

(52) U.S. Cl. CPC F02F 1/4285; F02F 1/4264; F02F 2001/244; F02F 1/243; F02F 11/002

(57) ABSTRACT

An apparatus for intake and exhaust of an engine includes: an outer tube including an outer-tube close end, an outer-tube open end, and a first outer-tube aperture set including a first aperture and a first outer-tube aperture group, an inner tube positioned in the outer tube about a concentric line, including an inner-tube close end, an inner-tube open end, and a first inner-tube aperture set including a second aperture and a first inner-tube aperture group, in which the inner-tube close end is proximate to the outer-tube close end, and a shaft connected to the inner-tube open end for rotating the inner tube in the outer tube about the concentric line, in which when the inner tube rotates, the second aperture sweeps across a portion of the first aperture and the first inner-tube aperture group sweeps across a portion of the first outer-tube aperture group.

### CROSS-REFERENCE TO RELATED APPLICATION(S)

This application claims priority to Chinese Patent Application No. 201710661831.7, filed on Aug. 4, 2017, which claims priority to U.S. Provisional Patent Application Ser. No. 62/501,403, filed on May 4, 2017, the contents of both of which are hereby incorporated by reference in their entireties.

### TECHNICAL FIELD

This disclosure relates to internal combustion engines (ICEs), and in particular, to an ICE cylinder head integrated with tubular variable intake and exhaust systems.

### BACKGROUND

A reciprocating internal combustion engine (ICE) includes two parts: an engine body (cylinder block) and a cylinder head. The cylinder block includes several cylinders for pistons to reciprocate within, typically moving in a four-stroke cycle of a four-stroke engine. For a four-stroke engine, the four strokes can include an intake stroke, a compression stroke, a power stroke (or an “expansion stroke”), and an exhaust stroke. In the intake stroke, air or an air/fuel mixture (AFM) is pulled by a piston into the cylinder through intake valves. In the compression stroke, the air or AFM is compressed by the piston in preparation for ignition. In the power stroke, the compressed AFM or air (or, for a diesel engine, diesel is injected into the compressed air in the cylinder) is ignited to push the piston for mechanical work production. In the exhaust stroke, exhaust gas is pushed out of the cylinder by the piston through exhaust valves. The piston is connected to a crankshaft through a connecting rod to convert its reciprocation into a revolution of the crankshaft for output.

The intake and exhaust valves and other related parts (collectively referred to as a “valvetrain”) are located in the cylinder head. The intake and exhaust valves are controllable to open and close in a timely order for the four-stroke cycles. Typically, the opening and closing timing (or simply “timing”) of the intake and exhaust valves are actuated by camshafts with cam lobes, which are driven by a timing belt/chain connected to the crankshaft. The valve timing depends on crankshaft angles and lob sharp angle. In addition, some modern ICEs use variable valve timing (VVT), variable valve lift (VVL), and direct fuel injection (FDI) to optimize fuel economy and power output, which can introduce complexity to the valvetrains. The valvetrains face growing challenges of increasing complexity, weight, friction, or manufacturing cost.

### SUMMARY

Disclosed herein are implementations of apparatuses and cylinder heads with tubular intake and exhaust systems.

In an aspect, an apparatus for intake and exhaust of an engine is disclosed. The apparatus includes an outer tube comprising an outer-tube close end, an outer-tube open end, and a first outer-tube aperture set comprising a first aperture and a first outer-tube aperture group comprising at least one aperture, an inner tube positioned in the outer tube about a concentric line, comprising an inner-tube close end, an inner-tube open end, and a first inner-tube aperture set comprising a second aperture and a first inner-tube aperture group comprising at least one aperture, wherein the inner-tube close end is proximate to the outer-tube close end, and a shaft connected to the inner-tube open end for rotating the inner tube in the outer tube about the concentric line, wherein when the inner tube rotates, the second aperture sweeps across a portion of the first aperture and the first inner-tube aperture group sweeps across a portion of the first outer-tube aperture group.

In another aspect, a cylinder head for an engine is disclosed. The cylinder head includes a cylinder head body, comprising a tubular cavity, a manifold port provided on the tubular cavity, connecting to a manifold of the engine, and a chamber port provided on the tubular cavity, connecting to a combustion chamber of the engine, and a tubular assembly, comprising an outer tube positioned in the tubular cavity, comprising an outer-tube close end, an outer-tube open end, and a first outer-tube aperture set comprising a first aperture and a first outer-tube aperture group comprising at least one aperture, an inner tube positioned in the outer tube, comprising an inner-tube close end, an inner-tube open end, and a first inner-tube aperture set comprising a second aperture and a first inner-tube aperture group comprising at least one aperture, wherein the inner-tube close end is proximate to the outer-tube close end, and a shaft connected to the inner-tube open end for rotating the inner tube in the outer tube, wherein the first aperture overlaps with a portion of the chamber port, the first outer-tube aperture group overlaps with a portion of the manifold port, and when the inner tube rotates, the second aperture sweeps across a portion of the first aperture and the first inner-tube aperture group sweeps across a portion of the first outer-tube aperture group.

### BRIEF DESCRIPTION OF THE DRAWINGS

The disclosure is best understood from the following detailed description when read in conjunction with the accompanying drawings. It is emphasized that, according to common practice, the various features of the drawings are not to scale. On the contrary, the dimensions of the various features are arbitrarily expanded or reduced for clarity.

FIG. 1A shows an example engine using an example cylinder head with two tubular systems according to implementations of this disclosure.

FIG. 1B shows internal structures of an example cylinder head with two tubular systems according to implementations of this disclosure.

FIGS. 2A-2B show an example cylinder head with a single tubular system according to implementations of this disclosure.

FIG. 3A shows an example cylinder head body with two tubular systems using a single-body design according to implementations of this disclosure.

FIG. 3B shows an example cylinder head body with two tubular systems using a two-body design according to implementations of this disclosure.

FIG. 3C shows an example cylinder head body with inlet ports and outlet ports according to implementations of this disclosure.

FIG. 3D shows an example cylinder head body with two tubular assemblies for intake and exhaust according to implementations of this disclosure.

FIGS. 4A-4B show an example engine using an example cylinder head with two tubular systems according to implementations of this disclosure.

FIG. 5 shows an example timing tube of a tubular assembly according to implementations of this disclosure.

FIG. 6A shows an example distribution tube of a tubular assembly according to implementations of this disclosure.

FIG. 6B shows an example separator plate for the distribution tube according to implementations of this disclosure.

FIG. 6C shows an example turbo plate for the distribution tube according to implementations of this disclosure.

FIG. 6D shows example designs for edges of example inner chamber ports or separators between the cylinders according to implementations of this disclosure.

FIG. 7A shows an example tubular assembly with a timing tube and a distribution tube according to implementations of this disclosure.

FIG. 7B shows another example tubular assembly with a timing tube and a distribution tube according to implementations of this disclosure.

FIG. 7C shows structures of a shaft head of an example distribution tube according to implementations of this disclosure.

FIGS. 7D-7E show an example tubular assembly with hydraulic actuators according to implementations of this disclosure.

FIGS. 7F-7N show example implementations of continuous VVL and VVT according to implementations of this disclosure.

FIG. 8 shows an example single-tube assembly for a 4-cylinder engine according to implementations of this disclosure.

FIGS. 9A-9B show an example engine using two tubular assemblies according to implementations of this disclosure.

FIG. 10 shows an example tubular assembly capable of cylinder deactivation according to implementations of this disclosure.

FIG. 11A is a diagram showing an example control logic of an engine control unit (ECU) according to implementations of this disclosure.

FIG. 11B is a diagram showing an example controller area network (CAN) of an engine according to implementations of this disclosure.

FIG. 12 is an example diagram of valve timing delay characteristic curves of an engine according to implementations of this disclosure.

### DETAILED DESCRIPTION

ICEs face challenges to increase fuel efficiency and decrease emissions. Higher fuel efficiency can be achieved via better mechanical structures of engines (e.g., with less weight or friction) and more accurate valvetrain management. One technical solution for those challenges is to variably control valve timing and valve lift of an engine in response to revolutions per minute (RPM) of the engine.

To reduce fuel consumption for an engine working at a low RPM, the amount of fresh air inflow can be decreased. For example, the valve lift can be decreased at a low or intermediate RPM. The valve lift can be increased at a high RPM.

Many ICEs work in an Otto cycle. To increase fuel efficiency, some engines can be adapted to work in an Atkinson/Miller cycle. If the engine can only work in the Atkinson/Miller cycle, one of the challenges is that the engine is difficult to be started at a low RPM. One technical solution for the challenge is to variably control valve timing and valve lift of an engine in response to the RPM. In some engines, the valve lift can be increased when the engine is working at a high RPM. For example, the engine can be started at the Otto cycle, then changed to the Atkinson/Miller cycle by continuously controlling the valve timings as its RPM increases. Better mechanical structures (e.g., with less weight or friction) and more accurate valvetrain management are strived for increasing fuel efficiency and decreasing emissions.

Typically, intake valves and exhaust valves are actuated by camshafts with cam lobes, and the camshafts are driven by the crankshaft of the engine through a timing chain or timing belt. It is difficult to independently control the intake valves and the exhaust valves. In addition, it is also difficult to continuously control the valve timing and the valve lift in response to a continuously changing RPM.

In this disclosure, an ICE cylinder head with tubular intake and exhaust systems are introduced. The ICE cylinder head can perform the Atkinson/Miller cycle and simplify the valve train to have fewer parts, lower friction, and reduced total weight and dimensions. It can continuously switch the engine working cycles from the Otto cycle to the Atkinson/Miller cycle. It can also be made to be compatible to existing engines.

The tubular intake and exhaust system can include one or more tubular assemblies, each including an inner tube and an outer tube. The inner tube can be configured to distribute the intake air or AFM, and thus can be referred to as a “distribution tube.” For ease of explanation without causing ambiguity, the “AFM or air” is referred to as “air” hereinafter unless explicitly described. The distribution tube can have flow areas controllable to change continuously as the RPM changes. The outer tube can be configured to control timing or phase of the intake and exhaust, and can be referred to as a “timing tube.” Actuators of the timing tube and distribution tube can be used to control the valve timing and “valve lift” independently and continuously. For the cylinder head that has two tubular assemblies for intake and exhaust, the actuators of their timing tubes and distribution tubes can be controlled continuously. In the disclosed cylinder head, the conventional camshaft valvetrain is not used, therefore the term “valve lift” does not refer to a “lift” of an actual valve, but is related to an effect of the disclosed cylinder head that can cause air flow cross-sectional areas (“flow area”) to change, which is similar to the effect of valve lift control in a conventional valvetrain. The change of the flow area can be continuous. The flow area can also be changed as the RPM changes. By using the tubular assemblies, the flow area can be changed with low flow restriction. The disclosed cylinder head can have fewer parts, simpler mechanical structures, reduced weight, smaller size, or more space for installation of other systems (e.g., a hybrid system or other attached components). By using the disclosed cylinder head, an engine can have less friction, less air flow restriction, better turbulences for a gasoline direct injection (GDI) system, better fuel efficiency, lower emissions, lower noise, lower vibration, easier accessibility, or lower costs for manufacture and maintenance. In addition, the engine using the disclosed cylinder head can be configured to implement continuous VVL and VVT, implement independent VVL and VVT control for intake and exhaust, run in the Atkinson/Miller cycle, perform cylinder deactivation, perform engine brake for a diesel engine and/or a controlled combustion engine (CCE), or implement homogeneous charge compression ignition (HCCI) or controlled auto ignition (CAI).

The disclosed cylinder head is compatible with conventional engine bodies. It can be interfaced with a conventional engine body and other components (e.g., sensors, wire harness, or engine oil adding port), which can minimize manufacturing costs.

The disclosed cylinder head can be manufactured as one piece or several parts (e.g., an upper half and a lower half). The disclosed cylinder head can also use a design to include a cylinder head for a diesel engine (e.g., used for heavy trucks). In addition, the disclosed cylinder head can be compatible with existing passage designs for lubricating systems and cooling systems of the ICE.

The cylinder head can include one or more tubular systems for intake/exhaust. A tubular system can include a tubular assembly and other components (e.g., for sealing, lubrication, cylinder separation, or actuation of the tubular assembly).

A tubular system can include two concentrically assembled tubes: a timing tube (or an “outer tube”) and a distribution tube (or an “inner tube”). The timing tube can include a manifold port (referred to as an “outer manifold port”) that interfaces with an intake manifold to pull air from the intake manifold, or an exhaust manifold to push exhaust gas into the exhaust manifold. The timing tube can also include a chamber port (referred to as an “outer chamber port”) that interfaces with a combustion chamber of a cylinder to let the air into the chamber or to let the exhaust gas out from the chamber. The distribution tube can include a manifold port (referred to as an “inner manifold port”) that overlaps with the outer manifold port to pull the air into the distribution tube from the intake manifold, or to push the exhaust gas out from the distribution tube into the exhaust manifold. The distribution tube can also include a chamber port (referred to as an “inner chamber port”) that overlaps with the outer chamber port to let the air into the chamber out from the distribution tube, or to let the exhaust gas into the distribution tube out from the chamber. The timing tube can include one or more outer manifold ports and one or more outer chamber ports. The distribution tube can include one or more inner manifold ports and one or more inner chamber ports. The term “port” herein refers to any combination of any shape of inlets, outlets, entrances, exits, holes, apertures, slits, windows, or any other openings on a surface for gas to flow through.

The distribution tube and the timing tube can be controlled independently. The overlapping between the inner and outer manifold ports can be adjustable. The overlapping between the inner and outer chamber ports can also be adjustable. The overlapping can be referred to as “flow areas.” The relative position of the distribution tube and the timing tube can be optimized for different engine RPMs or working conditions (e.g., oil pressures). The timing tube can be actuated by hydraulic motors or electric motors.

The distribution tube can be driven by a shaft to rotate inside the timing tube. The shaft can be driven by a timing belt/chain connected to a crankshaft. The distribution tube can distribute air (e.g., for GDI engines) or AFM (e.g., for port fuel injection engines or PFI engines) into the combustion chambers of the cylinders. The distribution tube can also be used to control valve lift variably and continuously by adjusting the flow area under different engine working conditions or RPMs, such as by moving it axially (along the direction of the shaft) relative to the timing tube. The flow area can be controlled based on oil pressure (e.g., measured by an oil pressure sensor). For example, the flow area can be controlled by an ECU based on a signal of an oil pressure sensor. The flow area can be calibrated based on a performance curve (e.g., a calibrated curve map) of the engine. The distribution tube can use internal structures (e.g., turbines) for intra-cylinder swirls and tumbles. The edge design of the inner chamber ports can also be optimized based on computational fluid dynamics (CFD) for less air friction, less charging flow restriction, or more inner turbulence and swirl in the combustion chamber.

The timing tube can be axially fixed and angularly adjustable inside the cylinder head. The timing tube can be adjusted to variably control “valve timing,” and such adjustments can be made continuously under different engine working conditions. In the disclosed cylinder head, a conventional camshaft valvetrain is not used, therefore the term “valve timing” does not refer to timing of an actual valve, but is related to an effect of controlling the timing of the strokes (e.g., the intake stroke, the compression stroke, the power stroke, and/or the exhaust stroke), which is similar to the effect of valve timing control in a conventional valvetrain. The timing tube can be adjusted to advance or delay the opening and/or closing timings for intake and exhaust, which can cause the engine to work in an Atkinson/Miller cycle.

The distribution tube and the timing tube can have different designs for their degrees of freedom (DOF) of movement. In some implementations, the timing tube can be axially fixed and the distribution tube is axially movable. In some implementations, the distribution tube can be axially fixed and the timing tube is axially movable. For ease of explanation without causing ambiguity, unless explicitly described, this disclosure describes example implementations hereinafter in which the distribution tube is axially movable and the timing tube is axially fixed inside the tubular cavity. It should be noted that modifications, variations, or alterations for designs of DOF for components of the tubular systems can be derived from the description of this disclosure.

The distribution tube and the timing tube can be electrically or hydraulically actuated to block some or all of the cylinders (e.g., by blocking ports of the cylinders, which will be explained hereinafter) to implement engine brake function, such as for a diesel engine (e.g., for a heavy truck). When intake inflows and exhaust outflows are blocked for selected cylinders, the selected cylinders can be deactivated (referred to as “cylinder deactivation”). Partial cylinder deactivation (i.e., not all of the cylinders are deactivated) can be used to increase fuel economy. Full cylinder deactivation (i.e., all of the cylinders are deactivated) can be used to implement engine brake.

The outer wall of the distribution tube and the inner wall of the timing tube are separated and lubricated to minimize friction. Compared with friction introduced by the camshaft or valve in conventional cylinder heads, the friction introduced by the disclosed cylinder head can be greatly reduced. The space between the outer wall of the distribution tube and the inner wall of the timing tube and the space between the outer wall of the timing tube and the cylinder head are sealed to prevent or minimize air (or exhaust) crossing into neighboring cylinders.

The structures and functions of the disclosed cylinder head with the tubular intake and exhaust systems will be described with reference to the accompanying drawings as follows.

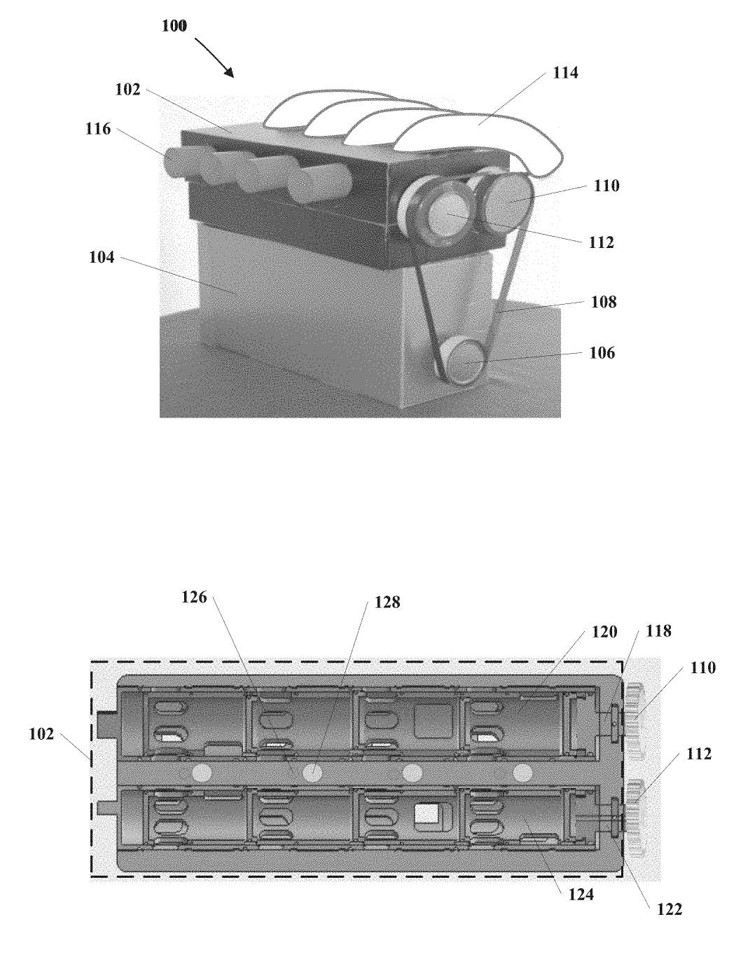

FIG. 1A shows an example engine 100 with an example cylinder head 102 with two tubular systems inside (not shown in FIG. 1A). The cylinder head 102 is mounted to an engine body 104. Compared with conventional cylinder heads, the cylinder head 102 includes no conventional valvetrain, thus it can have smaller dimensions and reduce the overall size of the engine.

The cylinder head 102 includes a tubular intake system (not shown) and a tubular exhaust system (not shown). A crankshaft is located inside the engine body 104 and connected to a crankshaft sprocket/pulley 106 outside of the engine body 104. The crankshaft sprocket/pulley 106 drives a first sprocket/pulley 110 and a second sprocket/pulley 112 via a timing chain/belt 108. The first sprocket/pulley 110 and the second sprocket/pulley 112 are fixed on a shaft of the tubular intake system and a shaft of the tubular exhaust system, respectively. An intake manifold 114 can be interfaced with the cylinder head 102 for providing air into combustion chambers (e.g., between the pistons and the cylinder walls) inside the engine body 104. An exhaust manifold 116 can be interfaced with the cylinder head 102 for letting exhaust gas out from the cylinders. The intake and exhaust manifolds can be on top or on side in different combinations of the cylinder head 102.

FIG. 1B shows internal structures of the cylinder head 102. In FIG. 1B, the first sprocket/pulley 110 and the second sprocket/pulley 112 are fixed on a first shaft 118 and a second shaft 122, respectively. The first shaft 118 and the second shaft 122 are connected to a first tubular assembly 120 and a second tubular assembly 124, respectively. For example, the first tubular assembly 120 can be used for air intake, and the second tubular assembly 124 can be used for exhaust, or vice versa. The first tubular assembly 120 and the second tubular assembly 124 can have the same or different dimensions (e.g., diameters). For example, as shown in FIG. 1B, the first tubular assembly 120 can have a larger diameter and the second tubular assembly 124 can have a smaller diameter. The first shaft 118 and the second shaft 122 can be driven by the timing chain/belt 108 connected to the crankshaft to rotate the distribution tubes of the first tubular assembly 120 and the second tubular assembly 124. In FIGS. 1A and 1B, the engine body 104 is below the cylinder head 102 and includes 4 cylinders. However, it should be noted that the tubular cylinder head can be adapted to interface with any number of cylinders (e.g., 3, 4, 5, 6, 8, 10, etc.) in any configuration (inline engines, V engines, W engines, H engines, etc.). In an example, installation positions for spark plugs and fuel injectors are located between the first tubular assembly 120 and the second tubular assembly 124. For example, a spark plug installation position 126 and a fuel injector installation position 128 can be located at the center of the cylinder head. The spark plugs and fuel injectors can be installed at other positions of the cylinder head 102. Further details about the cylinder head 102 and the tubular assemblies will be described below.

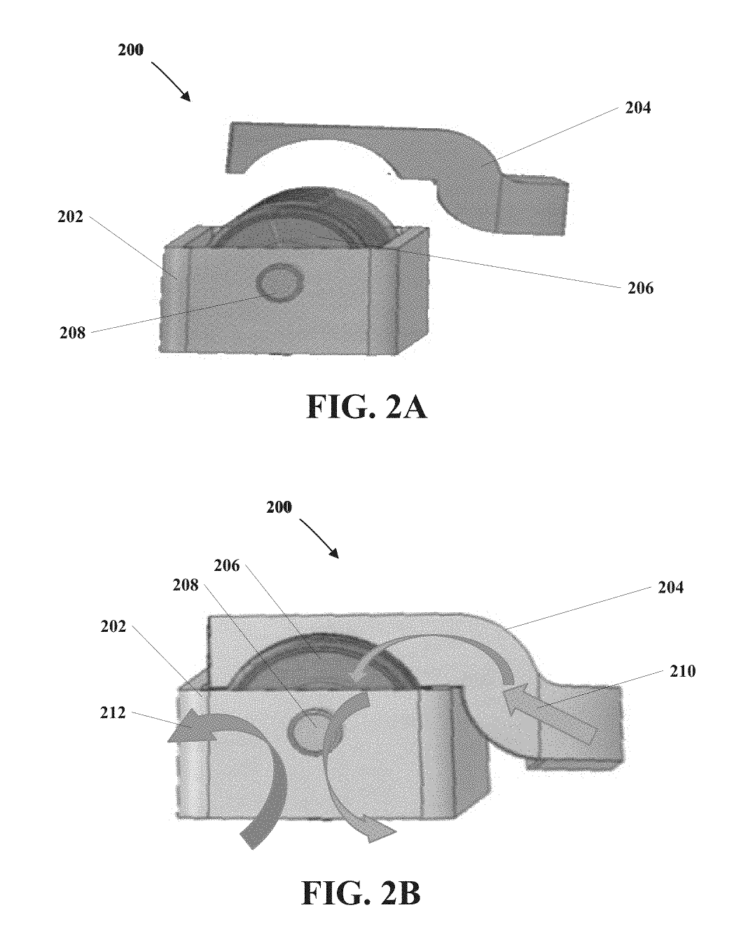

FIG. 2A shows an example cylinder head 200 with a single tubular system for intake and exhaust. The cylinder head 200 can also be interfaced with the engine body 104 in FIG. 1A. In FIG. 2A, an intake manifold 204 can be mounted to the cylinder head 200 on the top. A tubular assembly 206 can be located inside the cylinder head body 202 and can be interfaced with the intake manifold 204. The tubular assembly 206 can be connected to a shaft 208 that extends out of the cylinder head body 202. The shaft can be connected to a sprocket/pulley (e.g., the first sprocket/pulley 110 or 112 in FIGS. 1A-1B) and drive a distribution tube (not shown) of the tubular assembly 206 to rotate.

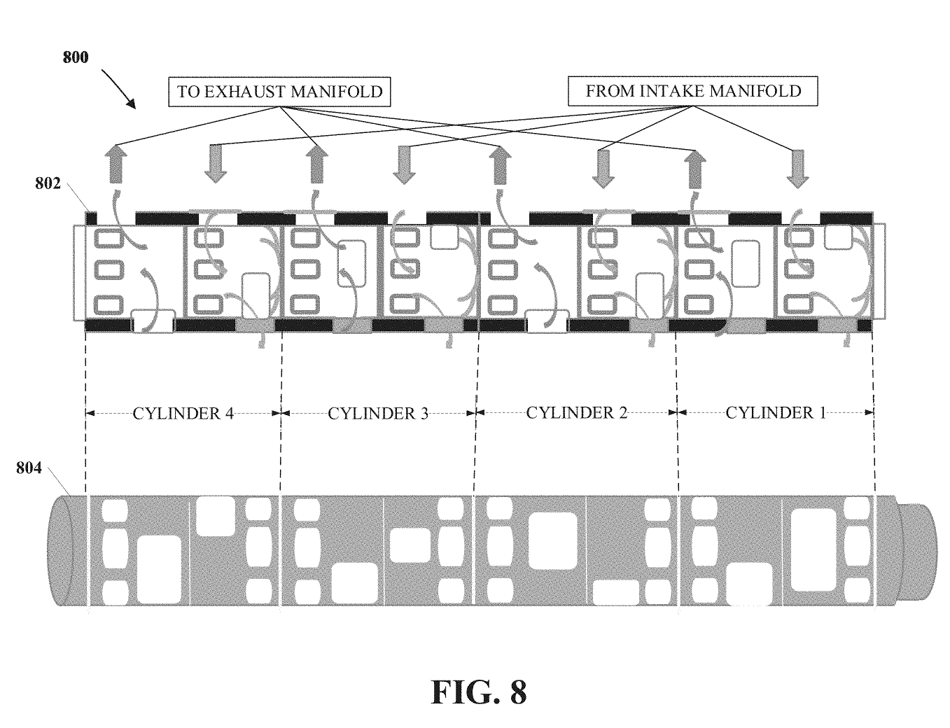

FIG. 2B shows the example cylinder head 200 in an assembled state. In FIG. 2B, the intake manifold 204 is mounted to the cylinder head body 202. An inner surface of the intake manifold 204 is interfaced with the tubular assembly 206. A distribution tube (not shown) of the tubular assembly 206 can be driven to rotate by the shaft 208. The tubular assembly 206 and the cylinder head body 202 include ports to provide a path for intake air inflow and exhaust gas outflow. An air inflow 210 (shown as one or more arrows) can be aspirated from the intake manifold 204 through the tubular assembly 206 to a combustion chamber. A fuel injector (not shown) can inject fuel into the combustion chamber, and a spark plug (not shown) can ignite the AFM. For example, the spark plug can be installed on the top of the cylinder head or on the side of the cylinder head body 202 (e.g., for an FDI engine). After combustion, exhaust gas outflow 212 (shown as one or more arrows) can be pushed out from the combustion chamber into the exhaust manifold (not shown) through the tubular assembly 206. Further details about the cylinder head body 202 and the tubular assembly 206 will be described below. Cylinder heads with a single tubular system as shown in FIGS. 2A-2B will be described in greater detail in the discussion of FIG. 8.

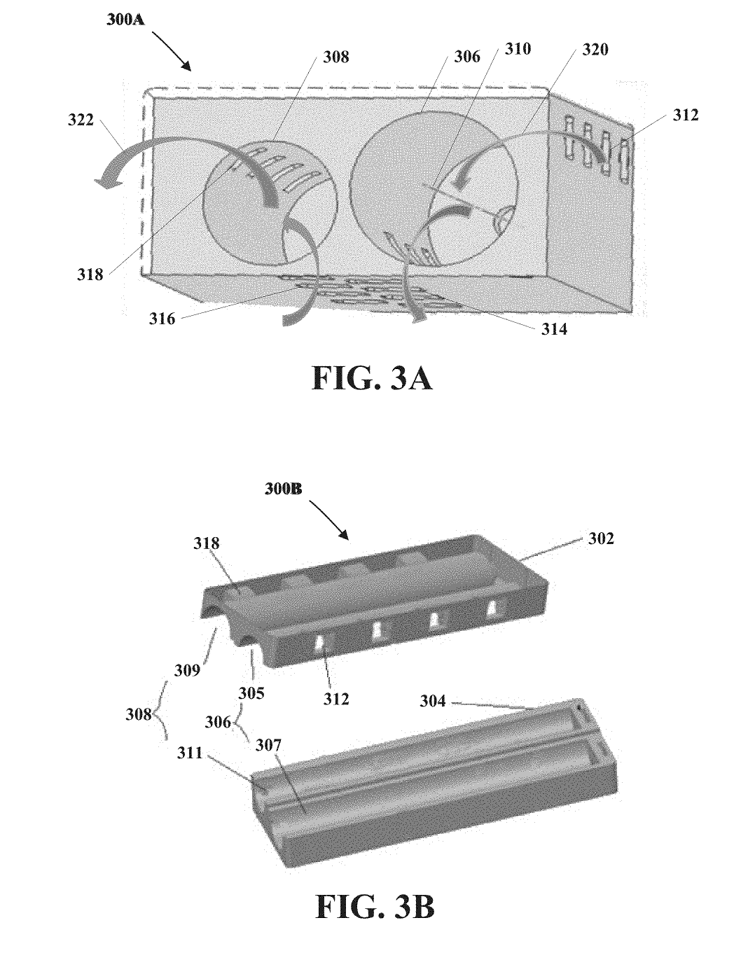

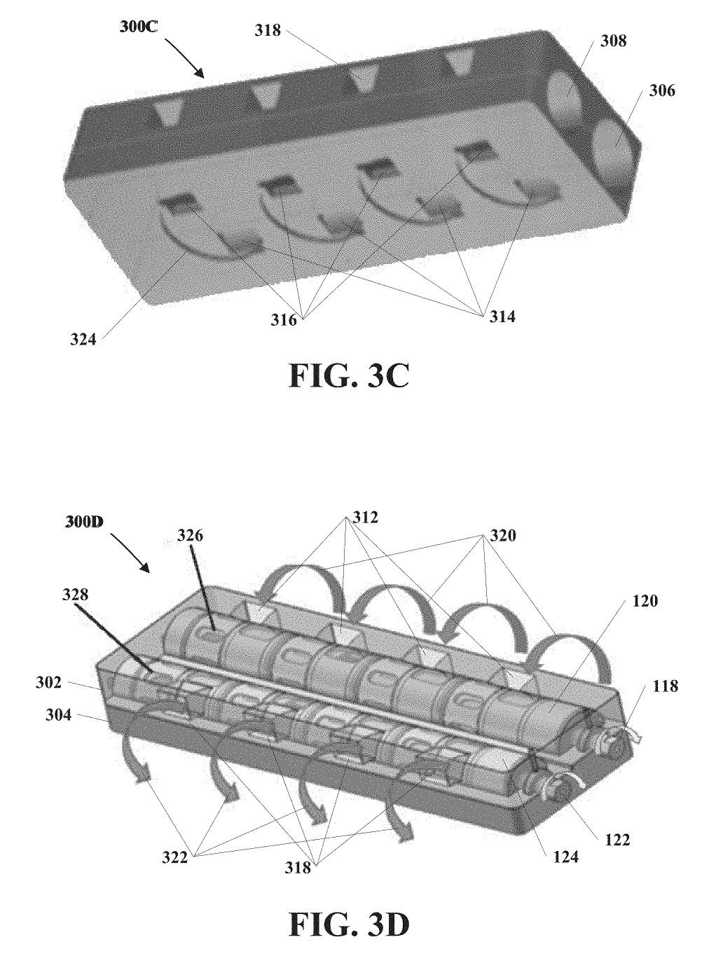

FIGS. 3A-3B show example cylinder head bodies 300A and 300B with two tubular systems for intake and exhaust. The cylinder head bodies 300A and 300B can be installed over an engine body (not shown) including multiple cylinders. In some implementations, the cylinder head body can be manufactured as one piece, such as the cylinder head body 300A. In some implementations, the cylinder head body can be manufactured as an upper body 302 and a lower body 304, such as the cylinder head body 300B. In some other implementations, without changing functions of the tubular assembly, the cylinder head body can be manufactured as pieces for assembling along the axial direction of the tubular assembly (e.g., each piece for a corresponding cylinder).

The cylinder head body 300A includes two tubular cavities: a tubular cavity 306 and a tubular cavity 308. For example, the tubular cavity 306 can be used for placing an intake tubular assembly (not shown), and the tubular cavity 308 can be used for placing an exhaust tubular assembly (not shown). A shaft for each tubular assembly can be installed aligned with a center line of each tubular cavity. For example, the shaft for the intake tubular assembly can be installed aligned with a center line 310 in the tubular cavity 306. The tubular assemblies can be installed inside the cylinder head body via lock features (not shown). Seal grooves (not shown) for sealing and lubrication can be made on the inner surfaces of the tubular cavities. The seal grooves will be described in greater detail in the discussion of FIG. 8. Cooling channels and lubricating channels (not shown) can be arranged in or around the cylinder dome. The tubular assemblies can also be interfaced with the cylinder head for heat radiation.

The cylinder head body 300A can include intake ports 312, inlet ports 314, outlet ports 316, and exhaust ports 318. The intake ports 312 can be interfaced with (e.g., using bolts or screws) an intake manifold (not shown) to provide air into the intake tubular assembly. The inlet ports 314 can be interfaced with (e.g., using bolts or screws) combustion chambers of cylinders under the cylinder head body 300A to provide air into the combustion chambers from the intake tubular assembly. The outlet ports 316 can be interfaced with (e.g., using bolts or screws) the combustion chambers to discharge exhaust gas into the exhaust tubular assembly from the combustion chambers. The exhaust ports 318 can be interfaced with (e.g., using bolts or screws) an exhaust manifold (not shown) to discharge exhaust gas from the exhaust tubular assembly. For example, each cylinder can be interfaced with an inlet port and an outlet port. An air inflow 320 (shown as arrows) shows a route of the air flowing from the intake manifold through an intake tubular assembly (not shown) to the combustion chambers. An exhaust outflow 322 (shown as arrows) shows a route of the exhaust gas flowing from the combustion chambers through an exhaust tubular assembly (not shown) to the exhaust manifold.

For large ICEs (e.g., diesel engines), to facilitate manufacturing and installation, the cylinder head body can be manufactured in pieces. For example, in FIG. 3B, the cylinder head body 300B includes the upper body 302 and the lower body 304. The upper body 302 and the lower body 304 can be connected by fasteners (e.g., bolts). The upper body 302 can include semicircular troughs 305 and 309. The lower body 304 can include semicircular troughs 307 and 311. When the upper body 302 and the lower body 304 are combined (e.g., by fastening), the semicircular troughs 305 and 307 can form the tubular cavity 306, and the semicircular troughs 309 and 311 can form the tubular cavity 308. One or more locking features (not shown) can be used to position tubular assemblies in the formed tubular cavities. The intake ports 312 and exhaust ports 318 are also shown in the upper body 302.

The intake ports 312, inlet ports 314, outlet ports 316, and exhaust ports 318 can be configured in any size, placement, configuration, or profile, and can be positioned anywhere at the cylinder head body (e.g., the cylinder head bodies 300A and 300B), as long as they are compatible with installation of other components of the engine (e.g., sensors, OMS, or hydraulic solenoids). For example, the intake ports 312 and exhaust ports 318 can be placed on a side surface of the cylinder head (e.g., as shown in FIGS. 3A-3B). For another example, the intake ports 312 and exhaust ports 318 can also be placed on a top surface of the cylinder head body, which can reduce flow restriction or air intake noise in some implementations.

FIG. 3C shows an example cylinder head body 300C with inlet ports 314 and outlet ports 316 at a bottom surface thereof. The cylinder head body 300C can be a one-piece component (e.g., the cylinder head body 300A) or a multi-piece component (e.g., the cylinder head body 300B). The exhaust ports 318 and the tubular cavities 306 and 308 are also shown in FIG. 3C. In some implementations, to mate with the chambers, the cylinder head body 300C can include cylindrical recesses, such as a cylindrical recess 324. The inlet ports and outlet ports can be arranged in the cylindrical recesses. The inlet ports and outlet ports can have various arrangements, such as being arranged on two sides of each chamber. To increase efficiency, as shown in FIG. 3C, the inlet ports 314 and outlet ports 316 are arranged diagonally for each chamber. The diagonal arrangement can boost the generation of in-chamber swirls and tumbles. The swirls and tumbles can mix the AFM to higher uniformity, which can increase fuel efficiency and performance of the ICEs.

FIG. 3D shows an example cylinder head body 300D with two tubular assemblies for intake and exhaust. The cylinder head body 300D includes the upper body 302 and the lower body 304. The upper body 302 includes the intake ports 312 and the exhaust ports 318. The two tubular assemblies include the first tubular assembly 120 and the second tubular assembly 124. In FIG. 3D, the first tubular assembly 120 can be used for intake and the second tubular assembly 124 can be used for exhaust. The first shaft 118 and the second shaft 122 are connected to the first tubular assembly 120 and the second tubular assembly 124, respectively. The first shaft 118 and the second shaft 122 can be driven by the crankshaft (e.g., through the crankshaft sprocket/pulley 106 and the first and second sprocket/pulley 110 and 112 in FIG. 1B) to rotate in a direction, such as the clockwise direction shown as arrows near them in FIG. 3D. The first tubular assembly 120 and the second tubular assembly 124 can include manifold ports, such as manifold ports 326 and 328. The manifold ports are apertures or holes on the tubular assemblies that, under rotation of the tubular assemblies, can sweep across the intake ports 312, exhaust ports 318, inlet ports (at the bottom of the lower body 304, not shown), and outlet ports (at the bottom of the lower body 304, not shown).

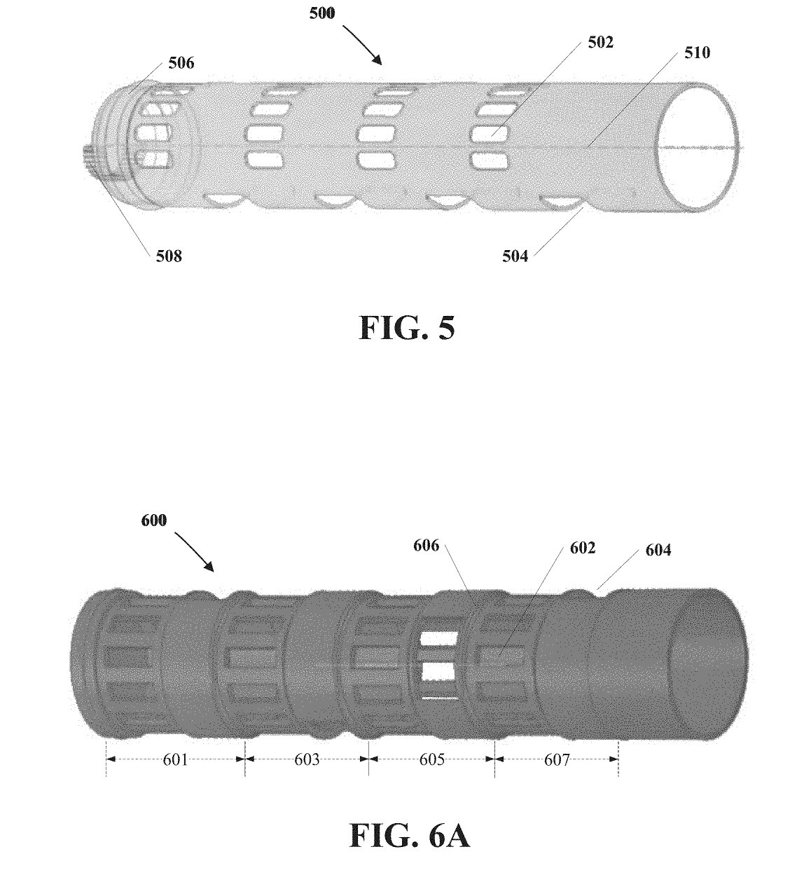

When a manifold port has an overlap region with an intake (or exhaust) port, the air (or exhaust gas) can enter (or leave) the tubular assembly. When the manifold port has an overlap region with an inlet (or outlet) port, the air (or exhaust gas) can enter (or leave) the corresponding chamber. By arranging the manifold ports on the surface of the tubular assemblies in a periodical circular fashion, when the tubular assemblies rotate, the air (or exhaust gas) can periodically enter (or leave) the chamber, such as following the air inflow 320 (or the exhaust outflow 322). By arranging the manifold ports on determined azimuthal angles about the driving axes (e.g., the first and second shafts 118 and 122) and matching them with crank angles of the cylinders, a firing order for the cylinders can be implemented. The tubular assemblies 120 and 124 can each include two tubes: an outer tube (referred to as a “timing tube”) and an inner tube (referred to as a “distribution tube”). Each of the timing tube and the distribution tube can include manifold ports of its own. For example, the manifold port 326 or 328 can be formed by an outer manifold port on the timing tube and an inner manifold port on the distribution tube. More details of the tubular assemblies will be described in FIGS. 5-11 and related description.

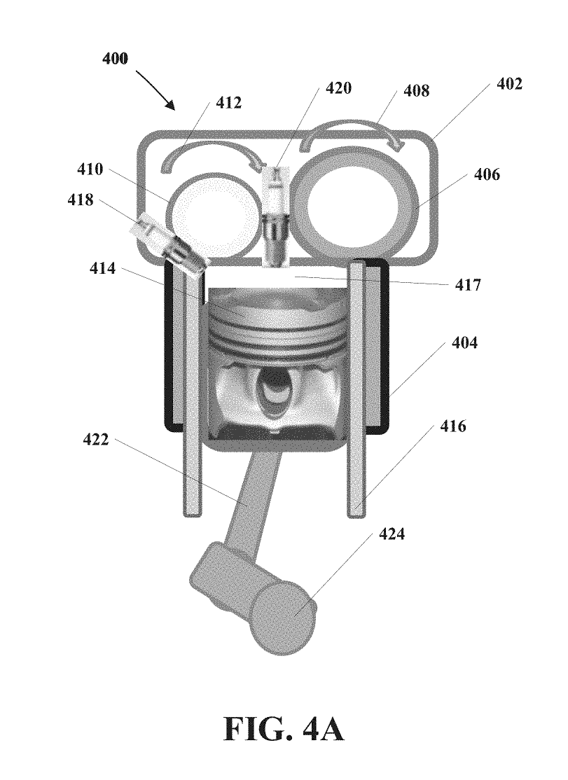

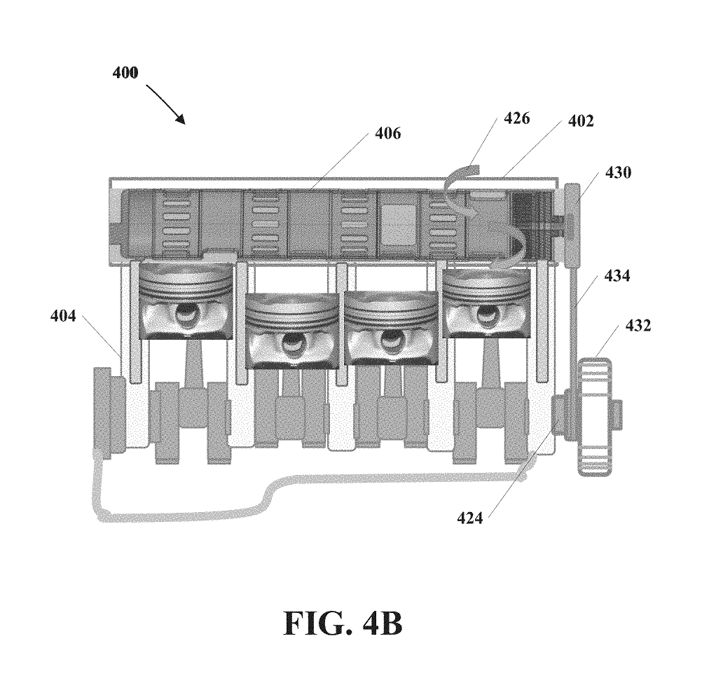

FIG. 4A shows a sectional side view of an engine 400 including an example cylinder head 402 with two tubular systems for intake and exhaust. The engine 400 can use a GDI design. However, other implementations of fuel injection are possible. The cylinder head 402 is installed on top of an engine body 404. The cylinder head 402 includes an intake tubular assembly 406 and an exhaust tubular assembly 410. The distribution tube (not shown) of the intake tubular assembly 406 is configured to rotate in a direction 408, and the distribution tube (not shown) of the exhaust tubular assembly 410 is configured to rotate in a direction 412. A piston 414 can reciprocate inside a cylinder 416 within the engine body 404. During the intake stroke, the piston 414 moves from the top dead center (TDC) to the bottom dead center (BDC), and air can be aspirated into a combustion chamber 417 via the intake tubular assembly 406. Fuel can be injected into the combustion chamber 417 by a fuel injector 418. During the compression stroke, the piston 414 moves from the BDC to the TDC to compress the AFM. During the power stroke, a spark plug 420 can ignite the AFM (or, if the engine 400 is a diesel engine, a diesel injector injects diesel into the combustion chamber 417 for self-ignition), and the combustion pushes the piston 414 to move from the TDC to the BDC again to produce mechanical work. The piston 414 is connected to a crankshaft 424 via a connecting rod 422, and the linear motion of the piston 414 can be converted to the revolution of the crankshaft 424 for output. During the exhaust stroke, the piston 414 moves from the BDC to the TDC again and pushes the exhaust gas out of the combustion chamber 417 through the exhaust tubular assembly 410.

FIG. 4B shows another sectional side view of the engine 400 with the cylinder head 402 installed on top of the engine body 404. FIG. 4B shows the intake tubular assembly 406. As shown in FIG. 4B, an air inflow 426 is entering a combustion chamber through the intake tubular assembly 406 (i.e., through the manifold ports). The intake tubular assembly 406 is being driven by a sprocket/pulley 430, which is connected via a timing chain/belt 434 to a crankshaft sprocket/pulley 432 installed on the crankshaft 424.

FIG. 5 shows an example timing tube 500 of a tubular assembly according to implementations of this disclosure. The tubular assembly can be used for intake (e.g., the intake tubular assembly 406), exhaust (e.g., the exhaust tubular assembly 410), or both (e.g., the tubular assembly 206). The timing tube 500 can be used to variably control intake and exhaust timing, functioning as a VVT control. The timing tube 500 can be placed inside a tubular cavity (e.g., the tubular cavity 306 or the tubular cavity 308) in the cylinder head. For example, if the cylinder head body is one-piece (e.g., the cylinder head body 300A), the timing tube 500 can be slid into the tubular cavity. For another example, if the cylinder body includes two parts (e.g., the cylinder head body 300B), the timing tube 500 can be placed into the lower body 304 first, and then covered with the upper body 302 mounted atop.

The timing tube 500 includes outer manifold ports 502 and outer chamber ports 504. For example, when the timing tube 500 is installed in the cylinder head body, the outer manifold ports 502 can be configured to overlap with the intake ports 312 or the exhaust ports 318. The outer chamber ports 504 can be configured to overlap with the inlet ports 314 or the outlet ports 316. In FIG. 5, the timing tube 500 can be used for a 4-cylinder engine because it includes 4 outer chamber ports 504 capable of overlapping with 4 inlet or outlet ports, and 4 sets of outer manifold ports 502 capable of overlapping with 4 intake or exhaust ports. Each set of the outer manifold ports 502 is distributed in a circular fashion on the surface of the timing tube 500. The outer manifold ports 502 can be configured in any suitable distribution, shape, or profile. The outer manifold ports 502 can be arranged as multiple parallel apertures for pneumatically connecting to the intake (or exhaust) ports, no matter what angle the timing tube 500 rotates relative to the tubular cavity. To maximize air inflows, the total area of the outer chamber ports 504 can be larger than the total area of the outer manifold ports 502.

For example, when the timing tube 500 is used in the intake tubular assembly 406, the air can flow from the intake manifold 114 to the intake tubular assembly 406 through the intake ports 312 and the outer manifold ports 502. The air will be charged into combustion chambers by a distribution tube (not shown) through the outer chamber ports 504 and the inlet ports 314. For another example, when the timing tube 500 is used in the exhaust tubular assembly 410, the exhaust gas can exit from the combustion chambers to the exhaust tubular assembly 410 through the outlet ports 316 and the outer chamber ports 504, and be discharged to the exhaust manifold 116 through the outer manifold ports 502 and the exhaust ports 318 by the distribution tube (not shown).

In an implementation, the distributions of the outer manifold ports 502 and the outer chamber ports 504 on the timing tube 500 can follow an engine cylinder order. For example, the first cylinder for air intake can be a cylinder using the TDC as a crankshaft alignment point and the TDC with an advanced angle as a start point. It should be noted that relative positions of the outer manifold ports 502 and the outer chamber ports 504 can be arranged on different positions on the timing tube 500. The relative positions can depend on engine layout and space availability. For example, in FIG. 5, when looking into the timing tube 500 along a center line 510, the outer manifold ports 502 can be defined as “ahead of” the outer chamber ports 504 in a clockwise direction. In some implementations, the outer chamber ports 504 can be arranged as behind the respective manifold ports 502 in the clockwise direction.

The timing tube 500 can be sealed (e.g., with a cap section) at a closed end 506 to prevent or minimize air or exhaust gas from escaping the timing tube 500 and provide mounting for exterior structures, such as a timing driving gear 508 (e.g., a half gear, a tap, or any other suitable gear). The timing driving gear 508 can be attached at the closed end 506 outside of the timing tube 500, and can be controllable to drive the timing tube 500 to rotate inside a tubular cavity (e.g., the tubular cavity 306 or the tubular cavity 308) about the center line 510. The center line 510 is also the axis with which a shaft (e.g., the first shaft 118 or the second shaft 122) of the distribution tube (not shown) is aligned.

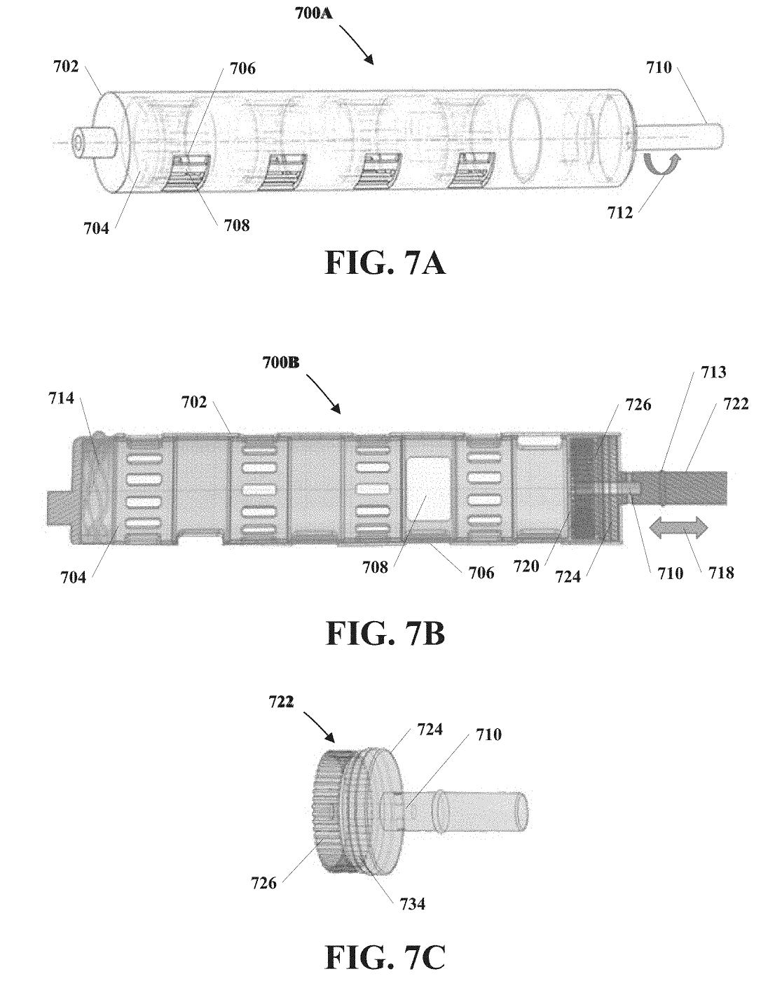

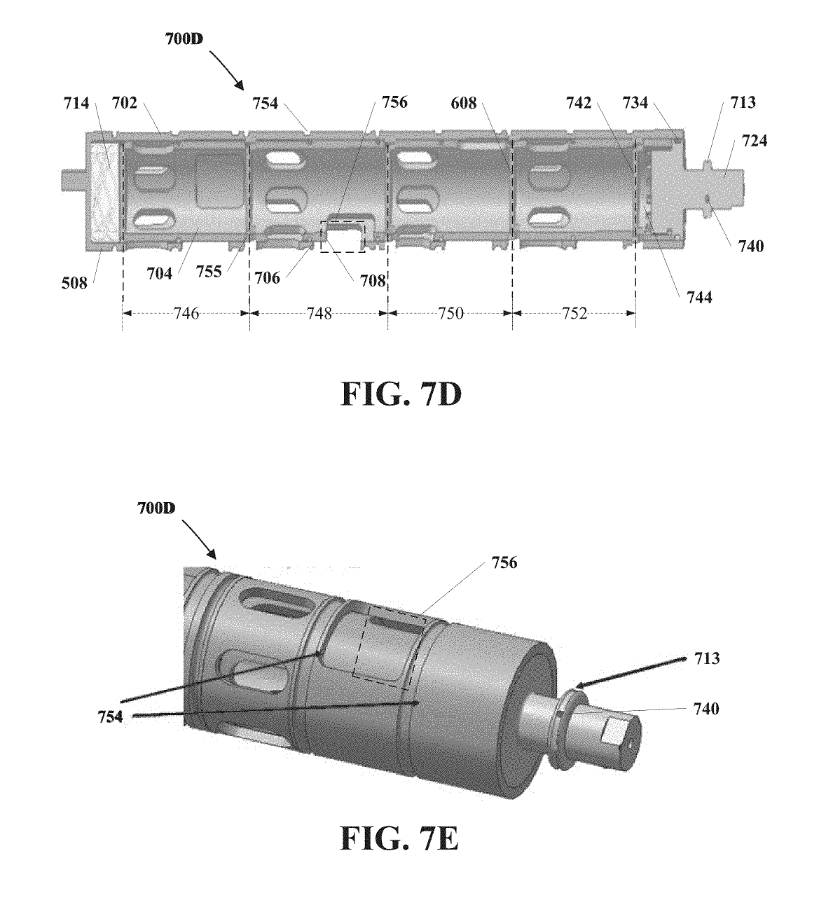

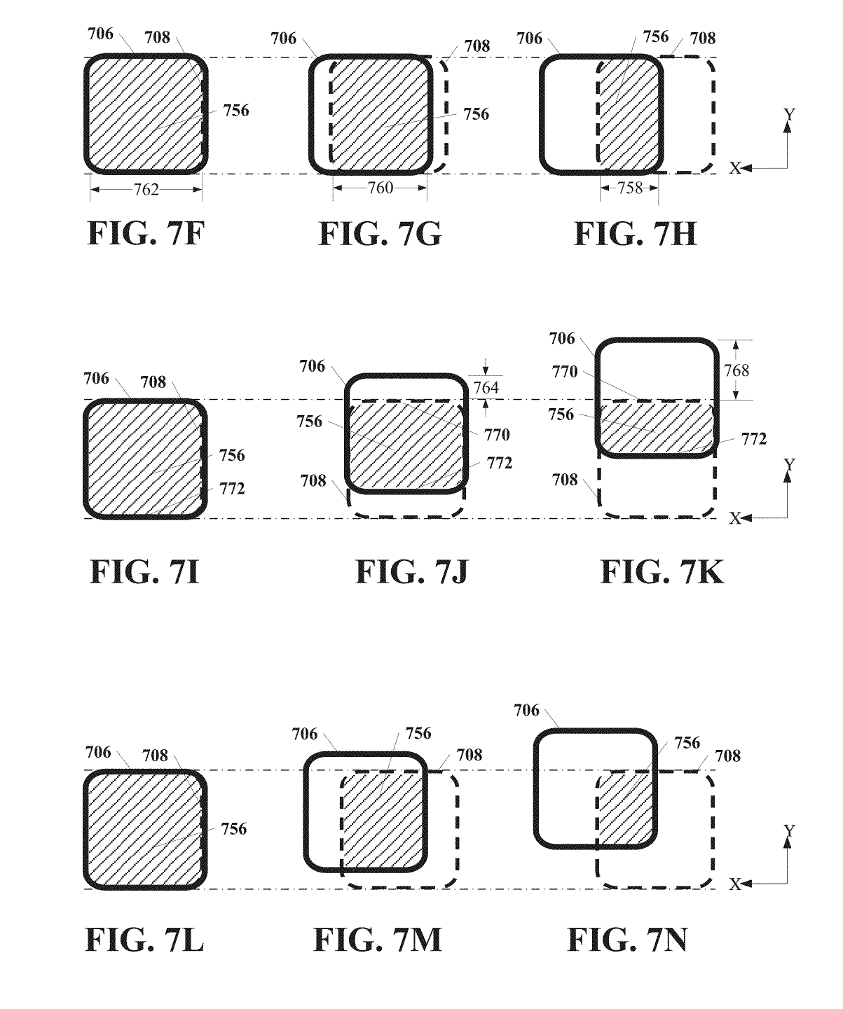

The timing driving gear 508 can be actuated by various means. For example, the timing driving gear 508 can be actuated through a driving worm gear (not shown) by an electric actuator (e.g., an electric step motor), a pneumatic actuator (e.g., a vacuum actuator), or a hydraulic actuator (e.g., a hydraulic solenoid valve). The actuation of the timing driving gear 508 can be controlled by an engine control unit (ECU). By rotating the timing tube 500, overlapped openings between the outer chamber ports 504 and the inlet/outlet ports can be adjusted to change the timing of when air inflows enter the combustion chambers and when exhaust outflows exit the combustion chambers. The changed timing can be used to change the engine working mode, such as switching between an Otto cycle and an Atkinson/Miller cycle. The details of controlling the timing for intake/exhaust will be described in FIGS. 7A-7N.

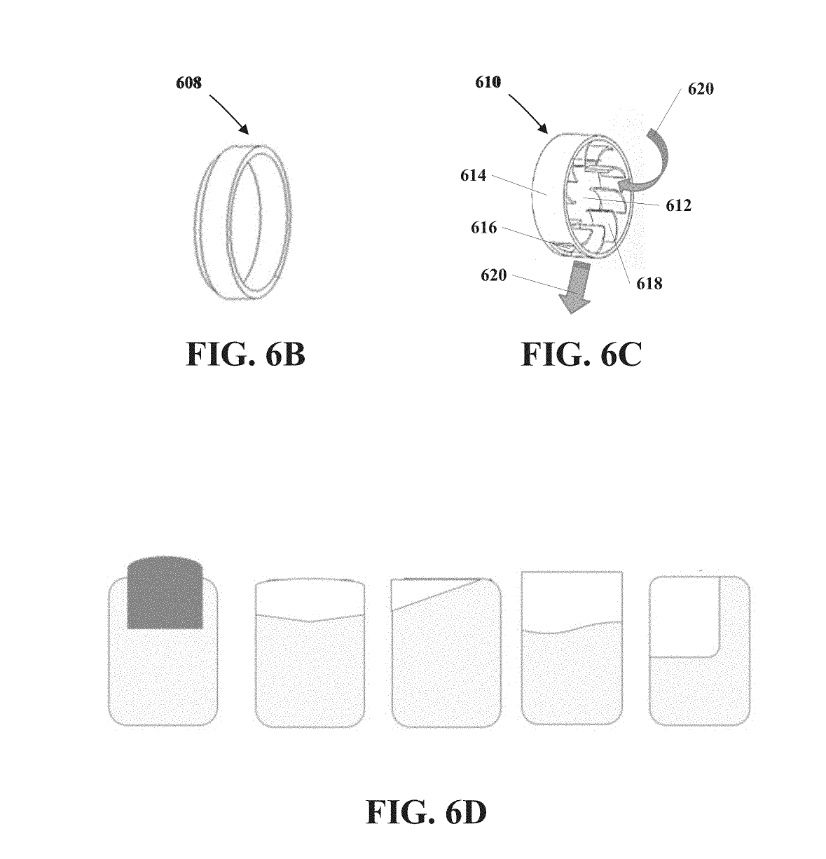

FIG. 6A shows an example distribution tube 600 of a tubular assembly according to implementations of this disclosure. The tubular assembly can be used for intake (e.g., the intake tubular assembly 406), exhaust (e.g., the exhaust tubular assembly 410), or both (e.g., the tubular assembly 206). The distribution tube 600 can be used for charging air into the combustion chambers or discharging exhaust gas out from the combustion chambers. The distribution tube 600 can be placed inside the timing tube 500 concentrically (e.g., commonly aligned with the center line 510). The distribution tube 600 can be connected to a shaft (e.g., the first shaft 118 or the second shaft 122), and driven to rotate inside the timing tube 500.

The distribution tube 600 includes inner manifold ports 602 and inner chamber ports 604. The inner manifold ports 602 can match with the outer manifold ports 502. The inner chamber ports 604 can match with the outer chamber ports 504. When rotating, the inner manifold ports 602 can sweep across the outer manifold ports 502, and the inner chamber ports 604 can sweep across the outer chamber ports 504. In an implementation, the distribution tube 600 can be used for intake. When the inner manifold ports 602, the outer manifold ports 502, and the intake ports 312 (not shown in FIG. 6A) have an overlap area, an air inflow (e.g., the air inflow 320) can be drawn into the distribution tube 600. When the inner chamber ports 604, the outer chamber ports 504, and the inlet ports 314 (not shown in FIG. 6A) have an overlap area, the air in the distribution tube 600 can be drawn into the chambers. In another implementation, the distribution tube 600 can be used for exhaust. When the inner chamber ports 604, the outer chamber ports 504, and the outlet ports 316 (not shown in FIG. 6A) have an overlap area, the exhaust gas can be discharged into the distribution tube 600. When the inner manifold ports 602, the outer manifold ports 502, and the exhaust ports 318 (not shown in FIG. 6A) have an overlap area, the exhaust gas in the distribution tube 600 can be discharged into the exhaust manifold (not shown in FIG. 6A) to form an exhaust outflow (e.g., the exhaust outflow 322). The aforementioned overlap areas can be referred to as “flow areas.”

In FIG. 6A, the distribution tube 600 can be used for a 4-cylinder engine because it includes 4 inner chamber ports 604 matched with 4 outer chamber ports 504, and four sets of inner manifold ports 602 matched with 4 outer manifold ports 502. Each set of the inner manifold ports 602 is distributed in a circular fashion on the surface of the distribution tube 600. The inner manifold ports 602 can be configured in any suitable distribution, shape, or profile. The inner manifold ports 602 can be arranged as multiple parallel apertures for pneumatically connecting to the outer manifold ports 502, no matter what angle the distribution tube 600 rotates relative to the timing tube 500. To maximize air inflows, a total area of a set of the inner chamber ports can be larger than a total area of the corresponding inner manifold port. The inner manifold port can have an area larger than any of the set of the inner chamber ports.

When the distribution tube 600 is rotating inside the timing tube 500, the inner manifold ports 602 can sweep across the outer manifold ports 502, and the inner chamber ports 604 can sweep across the outer chamber ports 504. When the inner manifold ports 602 have overlap with the outer manifold ports 502, the flow areas between them form and the intake/exhaust manifold is pneumatically connected to the distribution tube 600. When the inner chamber ports 604 have overlap with the outer chamber ports 504, the flow areas between them form and the distribution tube 600 is pneumatically connected to the combustion chambers.

For the distribution tube 600, each cylinder can be associated with a corresponding port group. The port group can include a set of inner manifold ports and an inner chamber port. For example, the inner manifold ports 602 and the inner chamber ports 604 can be divided into 4 tube sections 601-607 corresponding to 4 respective cylinders, each tube section including a port group. In some implementations, separator plates (not shown) can be used to separate and seal between the tube sections to prevent or minimize air (or exhaust gas) in a tube section from entering neighboring tube sections.

The positions of the inner chamber ports 604 and/or the inner manifold ports 602 on the distribution tube 600 can be arranged to match a cylinder firing order. For example, the inner chamber ports of the tube sections 601-607 can be arranged to open the cylinder in a firing order of 1-2-4-3. It should be noted that relative positions of the inner manifold ports 602 and the inner chamber ports 604 can be arranged on different positions on the distribution tube 600. The relative positions can depend on engine layout, space availability, and can match the design of the timing tube. For example, in FIG. 6, when looking into the distribution tube 600 (e.g., from the tube section 607 to the tube section 601), the inner manifold ports 602 can be defined as “ahead of” or “advancing” the inner chamber ports 604 in a clockwise direction, which matches with the arrangement of the outer manifold ports 502 and the outer chamber ports 504 of the timing tube 500 in FIG. 5. In some implementations, the inner chamber ports 604 can be arranged as behind the respective manifold ports 602 in the clockwise direction.

FIG. 6B shows an example separator plate 608 according to implementations of this disclosure. The separator plate 608 can be installed between the tube sections 601-607. For example, the separator plate 608 can be installed at position 606 inside the distribution tube 600 to separate the tube section 605 and the tube section 607. By using the separator plates, the air inflow or the exhaust outflow can be separated between each cylinder and thus increases flow smoothness and reduce inter-cylinder interference. The engine noise can be reduced. The strength of the distribution tube can also be reinforced to bear higher pressures from the combustion chambers. In some implementations, the separator plate 608 can be made by stamping or pressing.

In some implementations, the separator plates can utilize a turbine design for pushing the air inflow or pulling the exhaust outflow. The separator plates with turbine designs can be referred to as “turbo plates.” Functionally, the turbo plate 610 is similar to a turbocharger. The turbo plates can also help to create better turbulences inside the combustion chamber to improve the combustion.

FIG. 6C shows an example turbo plate 610. The turbo plate 610 includes a separator plate 612, a side wall 614, an opening 616, and turbines 618. The side wall 614 extends from the separator plate 612 so that the side wall 614 can cover the inner chamber ports 604. The opening 616 can be configured to overlap with the inner chamber ports 604 for circulation of air or exhaust gas. The turbines 618 can be fixed to the separator plate 608 and/or the inner wall of the side wall 614. When the turbo plate 610 is used in a distribution tube of an intake tubular assembly, an air inflow 620 can be aspirated into the rotating distribution tube via a set of inner manifold ports (e.g., the inner manifold ports of the tube section 607). Due to the rotation of the turbines 618, the pressure near the center of the turbo plate 610 is lower than the pressure near the rim of the turbo plate 610. In other words, the turbines 618 apply pressure on the air inflow 620 and charge an increased amount of air (or the same amount of increased-pressure air) into a combustion chamber when the inner chamber ports overlap with the inlet ports. For example, at the end of the intake stroke, the flow areas are decreasing, and the air inflows can be compensated by using the turbines. When the turbo plate 610 is used in a distribution tube of an exhaust tubular assembly, due to the centrifugal force produced by the rotating turbines 618, the exhaust gas can be discharged or guided more rapidly from the chambers and forming more in-cylinder turbulence or swirl.

Shapes of the turbines 618 and edges of the inner chamber ports 604 can be optimized (e.g., using CFD techniques) to achieve stronger tumbles and/or swirls in the combustion chambers. Strong turbulence can result in better air/fuel mixing, faster flame propagation, and more efficient combustion. FIG. 6D shows example designs for the edges of the inner chamber ports 604 or separators between the cylinders. It should be noted that the shape of the edges of the inner chamber ports 604 can have various designs based on computation-based flow analysis, not limited to the listed examples.

FIG. 7A shows an example tubular assembly 700A with a timing (outer) tube 702 and a distribution (inner) tube 704. The tubular assembly 700A can be installed in a tubular cavity (not shown). The distribution tube 704 is concentrically installed inside the timing tube 702. When functioning, the timing tube 702 can be fixed at a certain angle relative to the cylinder head body by a timing driving gear (not shown), forming low areas between its outer chamber ports 706 and inlet ports of the tubular cavity. The distribution tube 704 can be connected to a shaft 710. The shaft can be locked to an axial position with respect to the cylinder head using a location lock feature (not shown). The shaft 710 can be fixed to and driven by a driving sprocket/pulley (not shown) connected to the crankshaft via a timing chain/belt. When functioning, the distribution tube 704 can be driven by the shaft 710 to rotate inside the timing tube 702 in a direction 712. When inner chamber ports 708 of the distribution tube and the outer chamber ports 706 form flow areas, the air (or the exhaust gas) in the distribution tube 704 can be charged into (or discharged from) combustion chambers.

The configurations of the outer chamber ports 706 and the inlet/outlet ports of the cylinder head are determined based on the number of cylinders. For example, the tubular assembly 700A can be used for four cylinders. In other words, the distribution tube 704 can include 4 tube sections. The inner chamber ports 708 can be arranged to charge the cylinders in a designed firing order (e.g., 1-2-4-3). For example, on the azimuthal plane (i.e., a plane perpendicular to the shaft 710) of the tubular assembly 700A, assuming the outer chamber ports 706 are all arranged at 0°, if inner chamber ports of the tube sections 1-4 are arranged at 0°, 90°, 270°, and 180°, respectively, then the cylinders can be ignited in the firing order 1-2-4-3. By arranging the inner chamber ports 708 on the distribution tube at different azimuthal angles, the inner chamber ports 708 and the outer chamber ports 706 can overlap with each other at different timing, by which the cylinders can have different firing orders.

By rotating the timing tube 702 in the tubular cavity (e.g., using the timing driving gear 508 ), the timings of opening the flow areas between the outer chamber ports 706 and the inlet/outlet ports can affect timing of the air (or the exhaust gas) entering (or exiting) the chambers. This is similar to VVT control on a conventional ICE. By adjusting the timings relative to default timings, the air (or the exhaust gas) can enter (or exit) the chambers earlier or later. For example, by delaying discharging the exhaust, the expansion cycle can be prolonged, and the Atkinson/Miller cycle can be implemented.

The flow areas between the inner chamber ports 708 and the outer chamber ports 706 can affect cross-sectional areas of air inflows and exhaust outflows. The flow areas of the air inflows can be referred to as “intake flow areas.” The flow areas of the exhaust outflows can be referred to as “exhaust flow areas.” For ease of explanation without causing ambiguity, the term “flow area” used hereinafter can refer to an intake flow area, an exhaust flow area, or both. By changing the flow areas, the speed and/or amount of the air inflows and exhaust outflows can be controlled. This is similar to VVL (or duration) control on a conventional ICE. The flow areas can be adjusted by sliding the distribution tube 704 in a relative axial direction (axially inward or outward along the driving shaft 710 ) inside the timing tube 702. For example, the timing tube 702 can be axially fixed in the tubular cavity and the distribution tube 704 is slid. For another example, the distribution tube 704 can be axially fixed in the tubular cavity and the timing tube 702 is slid. It should be noted that it is effectively equivalent when either the distribution tube or the timing tube is axially fixed.

FIG. 7B shows internal structures of an example tubular assembly 700B. As shown in FIG. 7B, the distribution tube 704 is concentrically installed inside the timing tube 702. In some implementations, the timing tube 702 can be axially fixed. The distribution tube 704 can be actuated to move in an axial direction 718 relative to the timing tube 702.

To actuate the distribution tube 704, a resilience means 714 (e.g., a wave spring) can be placed at a first end (referred to as a “spring end”) of the tubular assembly 700B between the inner wall of the timing tube 702 and the outer wall of the distribution tube 704. The resilience means 714 can push the distribution tube 704 axially outward along the axial direction 718. The resilience means can be any other means that can bounce the distribution tube 704 axially under pressure.

In FIG. 7B, the distribution tube 704 can be provided with a tube gear 720 (e.g., an inner gear) fixed on the outer wall of its second end (referred to as a “shaft end”). The tube gear 720 can also be manufactured integrally with the distribution tube 704 (i.e., as a part of the distribution tube 704). The shaft end is opposite the spring end. The distribution tube 704 can be sealed at the shaft end. The shaft 710 can be concentrically inserted into a shaft head 722. The shaft head 722 can be attached to the driving sprocket/pulley (not shown) outside of the timing tube 702 for transferring the torque to the distribution tube 704.

The shaft head 722 can include a shaft gear 726 (e.g., an external gear) fixed on a shaft head body 724. The shaft head body 724 can be placed inside the timing tube 702 against its inner wall. The shaft gear 726 can slidingly engage the tube gear 720. The shaft head 722 can drive the distribution tube 704 to rotate inside the timing tube 702. Because of the sliding engagement between the shaft gear 726 and the tube gear 720, the distribution tube 704 can move axially along the axial direction 718 while being driven by the shaft head 722. For example, pressurized oil can be used to push the distribution tube inward, and the resilience means 714 can push the distribution tube outward when the oil pressure is released. It should be noted that various ways can be implemented to slidingly engage the tube gear 720 and the shaft gear 726, such as one or more gear teeth or keys, not limited to gears.

FIG. 7C shows structures of the shaft head 722. In FIG. 7C, the shaft head 722 includes the shaft head body 724 and the shaft gear 726 fixed thereto. In some implementations, the shaft gear 726 can be fixed onto the shaft head body 724. In some implementations, the shaft head body 724 and the shaft gear 726 can be manufactured as a single piece. In some implementations, the shaft head body 724 can include a groove for installing a seal 734 (e.g., an O-ring seal).

In some implementations, to axially actuate the distribution tube 704, electrical actuators (e.g., a stepping motor or a solenoid valve) can be used. In some implementations, hydraulic actuators (e.g., a pressure oil chamber) can be used.

FIGS. 7D-7E show an example tubular assembly 700D with hydraulic actuators. The tubular assembly 700D includes the distribution tube 704 and the timing tube 702. The timing tube 702 can be axially fixed. The hydraulic actuators can include a pressure oil chamber 744. The pressure oil chamber 744 can be formed by filling oil into the space between an oil chamber separator 742 and the shaft head body 724. In some implementations, the oil chamber separator 742 can be the same as the separator plate 608. The tube gear 720 and the shaft gear 726 are inside the pressure oil chamber 744. The seal 734 can seal the pressure oil inside the oil chamber 744 to prevent or minimize leaking of the pressurized oil. Oil can be pumped into or out from the pressure oil chamber 744 in a hydraulic oil path by an oil pump or an oil valve. For example, the shaft bead 713 can include an oil port 740 connected to the pressure oil chamber 744 (e.g., through an oil path inside the shaft 710). The oil can be pressurized to axially push the distribution tube 704. The oil path and the oil port can be manufactured by various methods, such as stamping, rolling, laser cutting, rolling, welding, or hydraulic forming.

By adjusting the oil pressure, the distribution tube 704 can be controlled to move axially with the reaction of the resilience means 714. For example, the oil path can be connected to the oil system of the engine and the oil volume and pressure inside the pressure oil chamber 744 can be controlled as the engine RPM changes. When the RPM increases, the oil pressure of the oil system can also increase, and oil can be pumped into the pressure oil chamber 744, in which the distribution tube 704 can be pushed axially inward (i.e., towards the resilience means 714 ) by the hydraulic pressure of the oil. When the RPM increases, the oil pressure of the oil system can also decrease, and the oil can be pumped out of the pressure oil chamber 744, in which the distribution tube 704 can be pushed axially outward (i.e., away from the resilience means 714 ) by the resilience means 714. In some implementations, if the distribution tube 704 is axially fixed and the timing tube 702 is axially movable, similar schemes can be used for controlling axial movement of the timing tube 702 using the hydraulic pressure of the oil and the resilience means, which will not be detailed hereinafter.

In FIG. 7D, the tubular assembly 700D can be separated into 4 tube sections 746-752 corresponding to respective cylinders. To prevent or minimize air or exhaust from crossing between the sections and reduce vibrations and frictions, the space between the timing tube and the distribution tube can be separated and sealed. In addition, the space between the tubular cavities and the timing tubes can also be separated and sealed. In some implementations, the sealing means can include seal grooves (or sealing steps) and gaskets (e.g., metal seals). The seals can be made of various materials that can withstand high temperature and pressure. The seals can also be made in various forms, such as C-rings, E-rings, O -rings, U-rings, or Omega seals. It should be noted that different sealing techniques (e.g., surface smoothing techniques) and sealing parts can be used depending on a manufacturing process and designed engine working conditions.

For example, timing-tube seal grooves including an example seal groove 754 can be arranged on the outer wall of the timing tube 702. The timing-tube seal grooves can form sealed hydraulic chambers for angular movement of the timing tube 702 inside the tubular cavity. Seals installed in the seal groove 754 can withstand high temperature and pressure, which can seal potential leak from the sealed section, and form a gap between the outer wall of the timing tube 702 for cooling the engine and lowering the frictions. For another example, distribution-tube seal grooves including an example seal groove 755 can be arranged on the outer wall of the distribution tube 704. The distribution-tube seal grooves can form sealed hydraulic chambers for axial movements of the distribution tube 704 inside the timing tube 702.

Lubricative coatings can be applied on bearing surfaces in the tubular systems to lower frictions. For example, the inner wall of the tubular cavity, the inner wall and the outer wall of the timing tube 702, and the outer wall of the distribution tube 704 can be coated with a layer of diamond-like carbon (DLC).

In some implementations, the distribution tube 704 can be set at a default or neutral position by adjusting the hydraulic pressure of the oil. For example, in FIGS. 7D-7E, the distribution tube 704 is at a default position in which it is axially pushed slightly inward. The default position of the distribution tube 704 can form default flow areas smaller than the fully overlapped openings between the outer chamber ports and the inner chamber ports (referred to as “maximum flow areas”). For example, a default flow area 756 (partially shown as a dash-line box in FIG. 7D) formed between the outer chamber port 706 and the inner chamber port 708 is smaller than the fully overlapped openings between them. The flow areas can be adjusted between the default flow areas and the maximum flow areas.

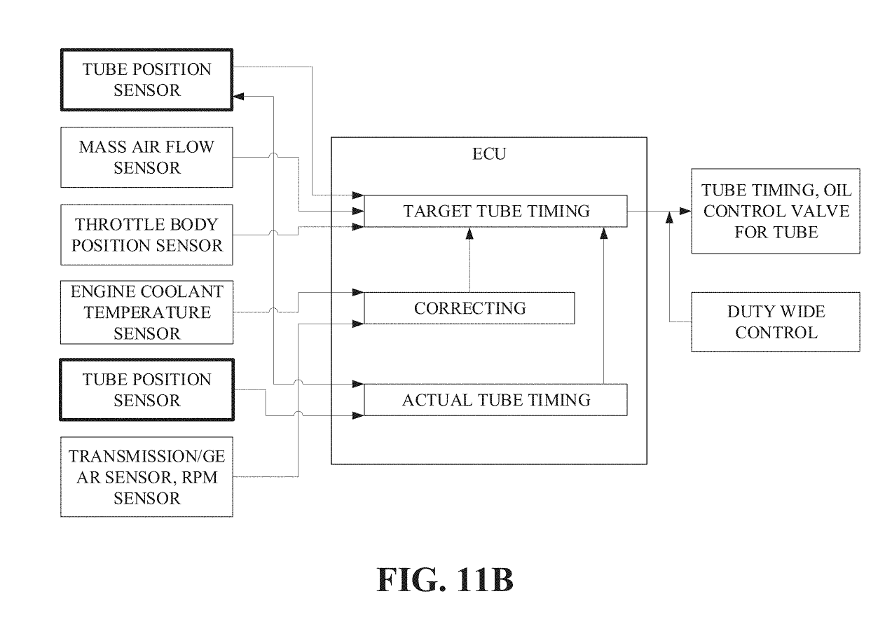

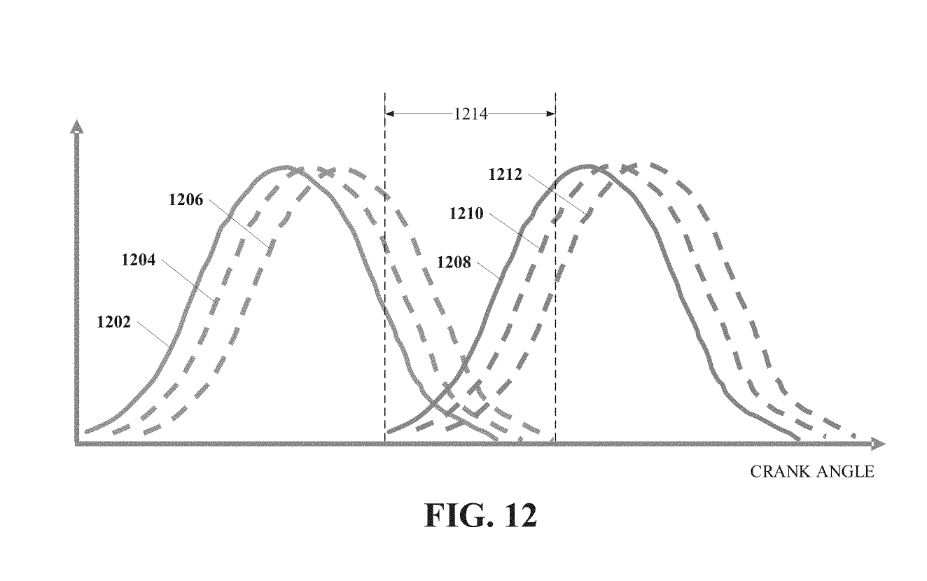

In some implementations, the flow areas can be adjusted according to engine working conditions. For example, the flow areas can be adjusted by controlling the oil pump or oil valve by the ECU based on the engine working conditions. The engine working conditions can include engine working modes (e.g., an Otto cycle or an Atkinson/Miller cycle), engine RPMs, oil pressures, throttle positions, engine temperatures, transmission gears, mass air flows, driving modes set by a driver, or any suitable type of parameters. The engine working conditions can be monitored using various sensors and fed back to the ECU to determine appropriate flow areas. The control of the flow areas will be detailed in FIGS. 11A-12.

For example, the default flow areas can be used when the engine is just started or running at low speed. The default flow areas can be set to be small, in which the engine can be easier to be started, more air can be charged into the chamber due to larger inertia, and the fuel efficiency can be increased. After starting the engine, the flow areas can be increased (e.g., continually or variably increased) to allow more air to be charged into the chamber. The flow areas can also be adjusted to change the valve timing for implementing the Atkinson/Miller cycle. In some implementations, the flow areas can be adjusted and controlled by the ECU in accordance with a calibrated performance map.

In some implementations, the size of the flow areas can be adjusted by adjusting the distribution tube axially. By adjusting the timing tube angularly, timings and/or phases for opening or closing the flow areas can be adjusted, such as intake opening timings, intake closing timings, exhaust opening timings, and exhaust closing timings. The intake/exhaust timings and phases herein refer to positions of the pistons and crankshafts of an engine when the intake/exhaust opens or closes. Details of adjusting the flow areas and the timings will be set forth in FIGS. 7F-7N.

FIGS. 7F-7N show example implementations of VVL and VVT continuously and simultaneously using the disclosed cylinder head. In FIGS. 7F-7N, looking from outside of the outer tube, a flow area 756 (shown as shades) is formed as a region overlapped by an outer chamber port 706 (shown in solid lines) and an inner chamber port 708 (shown in dash lines). The X direction represents a moving direction (e.g., away from the shaft head) of the inner tube for increasing the flow area 756. The Y direction represents a rotating direction of the inner tube. In FIGS. 7F-7N, the outer tube (and therefore the outer chamber port 706) is axially fixed and angularly movable, and the inner tube (and therefore the inner chamber port 708) is axially and angularly movable. When the inner tube is rotating in the fixed outer tube, the inner chamber port 708 sweeps across the fixed outer chamber port 706 along the Y direction. FIGS. 7F-7N show the same moment when the inner chamber port 708 sweeps across the same location of its rotational path, which is indicated by the dot-dash line.

FIGS. 7F-7H show example implementations of continuous VVL. The outer chamber port 706 is axially and angularly fixed, and the inner chamber port 708 is axially movable. In FIG. 7H, the inner chamber port 708 is at a first axial position (e.g., a default axial position), and the flow area 756 has a first width 758. In FIG. 7G, the inner chamber port 708 moves along the X direction to a second axial position, and the flow area 756 has a second width 760. In FIG. 7F, the inner chamber port 708 moves along the X direction to a third axial position, and the flow area 756 has a third width 762. In some implementations, the flow area 756 can be adjusted according to engine RPMs. For example, when the engine is just started or working at a low RPM, the flow area 756 can have a default width shown as the first width 758 in FIG. 7H. When the RPM increases, the inner chamber port 708 can be pushed to the second axial position as shown in FIG. 7G. When the engine is working at high RPM, the inner chamber port 708 can be pushed to the third axial position as shown in FIG. 7F. FIGS. 7F-7H only shows three example axial positions of the inner chamber port 708. It should be noted that the inner tube (and the inner chamber port 708 ) can be continuously shifted in the axial direction, and thus the flow area 756 can be continuously adjusted, by which the continuous VVL can be implemented for the engine.

In some implementations, if hydraulic actuators are used for the inner tube, when the RPM increases, the oil pressure also increases in the oil system that can cause oil to be pumped into the pressure oil chamber 744, by which the inner tube is pushed. In some other implementations, electric actuators can also be used for pushing the inner tube.

FIGS. 7I-7K show example implementations of continuous VVT. The outer chamber port 706 is angularly movable and axially fixed, and the inner chamber port 708 is axially fixed. In FIG. 7I, the outer chamber port 706 is at a first angular position. In FIG. 7J, the outer chamber port 706 is rotated (e.g., by using the timing driving gear 508) for a distance 764 with respect to the first angular position along the Y direction to a second angular position. In FIG. 7K, the outer chamber port 706 is rotated for a distance 768 with respect to the first angular position along the Y direction to a third angular position. The timing of opening and closing the flow area 756 (referred to as “valve opening timing” and “valve closing timing”, respectively) depend on when an upper edge 770 of the inner chamber port 708 sweeps across a lower edge 772 of the outer chamber port 706. As the outer chamber port 706 (and the lower edge 772) is rotated along the Y direction, the valve opening timing and/or the valve closing timing (collectively referred to as “valve timing”) is delayed. Alternatively, as the outer chamber port 706 (and the lower edge 772) is rotated against the Y direction, the valve timing is advanced.

The delayed valve timing can be used for switching the engine from working in the Otto cycle to the Atkinson/Miller cycle. FIGS. 7I-7K only shows three example angular positions of the outer chamber port 706. It should be noted that the outer tube (and the outer chamber port 706) can be continuously rotated in the angular direction, and thus the valve timing can be continuously adjusted, by which the continuous VVT can be implemented for the engine.

In some implementations, the valve timing can be adjusted according to engine working conditions. For example, when the engine is just started, the default valve timing can be shown in FIG. 7H, in which the outer chamber port 706 is at the first angular position. After the engine is started, the outer chamber port 706 can be continuously rotated (e.g., from the first to the third angular position as shown from FIG. 7I to FIG. 7K). The valve timing can be continuously delayed until a full Atkinson/Miller cycle is achieved. The outer chamber port 706 can stay at the advanced position to keep the engine running in the Atkinson/Miller cycle.

FIGS. 7L-7N show example implementations of simultaneously performing the continuous VVL and the continuous VVT. In FIGS. 7L-7N, the outer chamber port 706 is axially fixed and angularly movable, and the inner chamber port 708 is axially movable. The outer chamber port 706 can be controlled in a way similar to FIGS. 7I-7K, and the inner chamber port 708 can be controlled in a way similar to FIGS. 7F-7H. The flow area 756 can be controlled in two DOFs (i.e., the angular direction and axial direction). The movement of the outer chamber port 706 and the inner chamber port 708 can be controlled independently or interdependently depending on different working modes, in which the VVL and VVT can be performed continuously and simultaneously. By implementing continuous VVL and continuous VVT simultaneously, the fuel economy can be improved, the engine responsiveness to ECU MAP can be faster and more accurate, and switching engine working cycles can be easier.

It should be noted that for an engine using two tubular systems for intake and exhaust, the flow areas and valve timing for the intake and exhaust tubular assemblies can be controlled independently or interdependently. For example, the valve timing of the intake and exhaust tubular assemblies can be delayed at different times (i.e., non-simultaneously). For another example, the flow areas of the intake and exhaust tubular assemblies can be different.

In FIGS. 7F-7N, the outer chamber port 706 is shown as having the same or substantially the same profile and size as the inner chamber port 708. It should also be noted that the profiles and sizes of the outer chamber port 706 and the inner chamber port 708 can be implemented in various ways, not limited to the ones shown in FIGS. 7F-7N.

According to implementations of this disclosure, an engine can use the disclosed cylinder head with either one or two tubular systems. For small engine designs, the cylinder head can use a single-tube design that integrates intake sections and exhaust sections into a single-tube assembly. In the single-tube assembly, the timing of the charging and exhaust is determined by relative positions of the chamber ports. The single-tube assembly can further reduce weight and dimension of the cylinder head.

FIG. 8 shows an example single-tube assembly 800 for a 4-cylinder engine. The single-tube assembly 800 can be used in a gasoline engine of a passenger car, or a diesel engine of a heavy truck. The single-tube assembly 800 includes a timing tube 802 and a distribution tube 804, which are shown in parallel. The single-tube assembly 800 can be divided into 4 sections corresponding to cylinders 1-4. Each section of the distribution tube can include an intake sub-section and an exhaust sub-section. The intake sub-sections can charge air into the cylinders from an intake manifold, and the exhaust sub-sections can discharge the exhaust gas to an exhaust manifold. In FIG. 8, the positions of inner chamber ports of the distribution tube 804 can be arranged to implement a firing order of 1-2-4-3 (e.g., by arranging inner chamber ports of the tube sections 1-4 at 0°, 90°, 270°, and 180°, respectively). Due to the single-tube design, the valve timing and the valve lift are adjusted interdependently for the single-tube assembly 800.

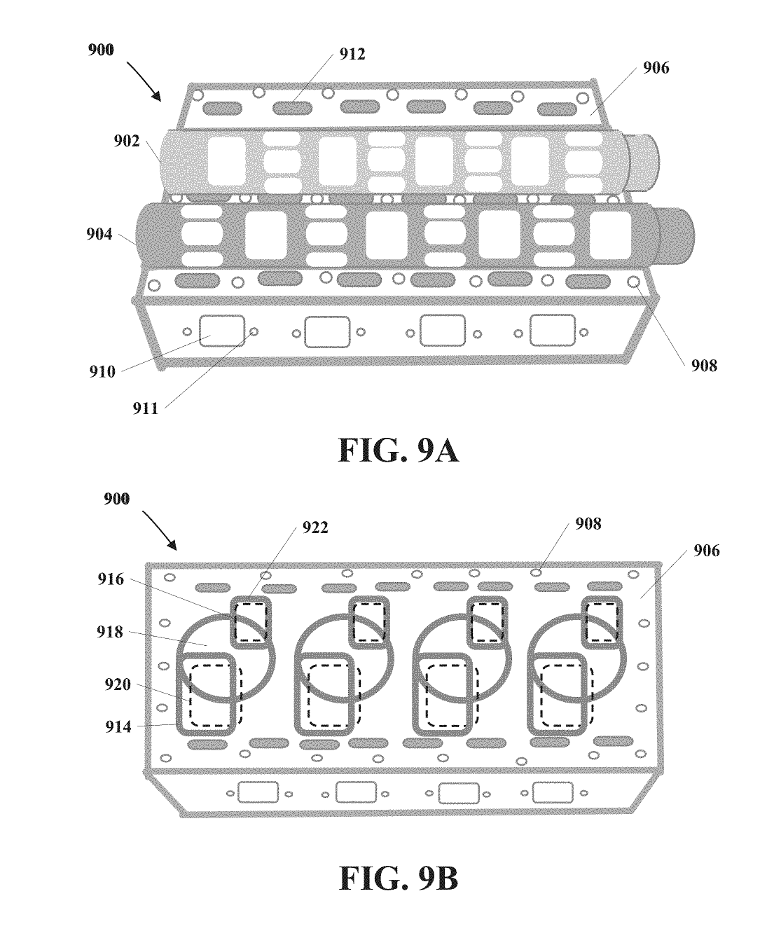

FIGS. 9A-9B show part of an example cylinder head 900 using two tubular assemblies. FIG. 9A shows a top side of the cylinder head 900. The cylinder head 900 includes an intake tubular assembly 902 and an exhaust tubular assembly 904, which are on top of a lower body 906. The upper body of the cylinder head 900 is not shown. The lower body 906 includes mounting holes 908 (e.g., bolt holes) for mounting the upper body of the cylinder head 900, exhaust ports 910, manifold mounting holes 911 (e.g., bolt holes) for mounting intake/exhaust manifold to the lower body 906, and cooling circulating ports 912 for circulating cooling liquids.

FIG. 9B shows a bottom side of the lower body 906. The lower body includes mounting holes 908 (e.g., bolt holes) for mounting the lower body 906 on top of an engine body (not shown). The lower body includes an inlet port 914 and an outlet port 916. The inlet port 914 and the outlet port 916 can be interfaced with a combustion chamber opening 918 (combustion chamber not shown). When the lower body is mounted onto the engine body, the combustion chamber opening 918 can be aligned with a combustion chamber and sealed. An outer chamber port 920 (shown as a dash-line box) of the intake tubular assembly 902 and the inlet port 914 (shown as a solid-line box) forms an intake flow area. An outer chamber port 922 (shown as a dash-line box) of the exhaust tubular assembly 904 and the outlet port 916 (shown as a solid-line box) forms an exhaust flow area. In some implementations, the intake and exhaust flow areas can be adjusted independently. As shown in FIG. 9B, the first flow area is smaller than the maximum intake flow area, while the second flow area is the maximum exhaust flow area.

In some implementations, the timing tube of the tubular system can be used to implement engine braking and/or deactivating one or more cylinders (referred to as “cylinder deactivation”) by selectively blocking some or all of the cylinders. When a cylinder is blocked at its inlet or outlet port, the air inflow or the exhaust outflow of the cylinder is substantially stopped from entering or exiting the cylinder.

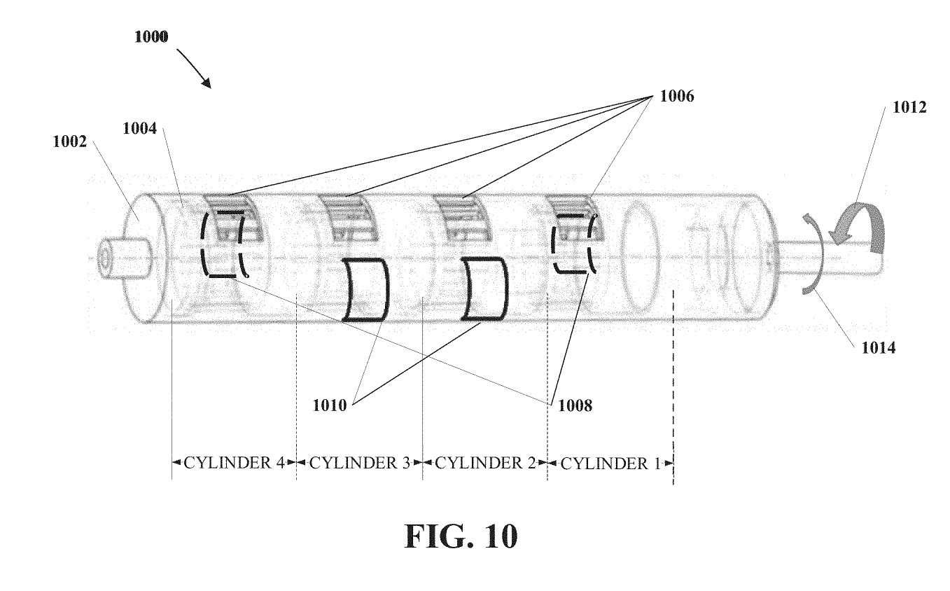

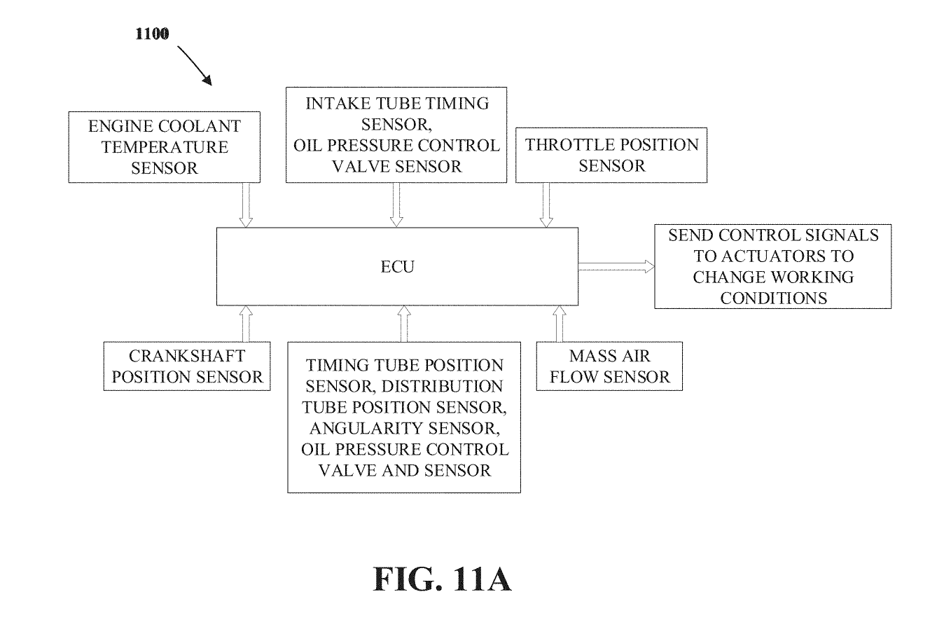

FIG. 10 shows an example tubular assembly 1000 with an example design for cylinder deactivation and/or engine braking. The tubular assembly 1000 can be used for a 4-cylinder engine. The tubular assembly 1000 includes a timing tube 1002 and a distribution tube 1004. The timing tube 1002 can include 3 sets of outer chamber ports: first outer chamber ports 1006, second outer chamber ports 1008 (on the back, invisible, shown in dashed lines), and third outer chamber ports 1010 (in the front, visible, shown in solid lines). The timing tube 1002 can be rotated (e.g., driven by a timing driving gear) in a first direction 1012 (counterclockwise looking from the cylinder 1 to the cylinder 4) or a second direction 1014 (clockwise looking from the cylinder 1 to the cylinder 4). When an outer chamber port forms an overlapped area (e.g., the flow area 756) with an inlet/outlet port (not shown), the cylinder corresponding to the inlet/outlet port is unblocked (or “activated”) for air inflows or exhaust outflows. When the overlapped area is zero, the cylinder is blocked (or “deactivated”). The engine braking and cylinder deactivation functions can use similar timing positions of the timing tube 1002. The cylinder deactivation can be implemented by blocking some of the cylinders. The engine braking function can be implemented by blocking all cylinders, in which the engine can work like an air compressor that increases friction to the power train.

For example, in an implementation, the first outer chamber ports 1006 can be used by default, which activates the 4 cylinders. When the timing tube 1002 is rotated in the first direction 1012 for a first degree, the second outer chamber ports 1008 can align with the inlet/outlet ports of the cylinders 1 and 4, in which the cylinders 1 and 4 are activated (or the cylinders 2 and 3 are deactivated). When the timing tube 1002 is rotated in the second direction 1014 for a second degree, the third outer chamber ports 1010 can align with the inlet/outlet ports of the cylinders 2 and 3, in which the cylinders 2 and 3 are activated (or the cylinders 1 and 4 are deactivated). The timing tube 1002 is rotated in the first direction 1012 or the second direction 1014 for a third degree such that no outer chamber port aligns with the inlet/outlet ports of any of the cylinders 1-4, in which all of the cylinders 1-4 are deactivated and the engine braking function starts.

The disclosed cylinder head integrated with tubular systems can be controlled by an engine control unit (ECU). Engine working conditions can be measured by various sensors and fed back to the ECU. Based on the sensed engine working conditions, the flow areas and the timing positions can be automatically adjusted by the ECU through electric or hydraulic actuators. The ECU is also upgradeable to adapt to performance needs of the engine via software development. Compared with conventional VVL and VVT techniques, the disclosed cylinder head can control the intake flow area and the exhaust flow area independently. The disclosed cylinder head can also control the flow areas and the timing positions independently. The disclosed cylinder head can achieve more precise and continuous control for the flow areas and the intake/exhaust timings, better engine performance, and higher fuel economy.

In some implementations, the sensors can include an engine coolant temperature sensor, an oil pressure sensor, an oil pressure control valve sensor, a throttle position sensor, a crankshaft position sensor, a mass air flow sensor, an intake tube timing sensor, a timing tube position sensor, a distribution tube position sensor, an angularity sensor, a transmission/gear sensor, an RPM sensor, or any other sensor for measuring engine working conditions. The data collected by the sensors can be inputted to the ECU to determine actual tube positions (e.g., the flow areas and timing positions), and calculate target tube positions for a target flow area and a target timing position for optimization of fuel economy and emission reduction while maintaining the power output of the engine.

For example, based on an oil pressure collected by the oil pressure sensor, the ECU can determine an engine working condition (e.g., at a low RPM), and actuate (e.g., via a hydraulic valve or an electric solenoid valve) one or more timing tubes to axially move with respect to their corresponding distribution tubes to change the intake/exhaust flow areas. In addition, the ECU can also actuate the timing tubes to change the timing positions for switching the engine to work in different modes (e.g., the Atkinson/Miller cycle and the Otto cycle). For example, when the engine decreases its RPMs, the flow areas can be automatically decreased, and the timing positions can be automatically set for the engine to run in an Atkinson/Miller cycle. When the engine increases its RPMs, the flow areas can be automatically increased, and the timing positions can be automatically set for the engine to run in an Otto cycle. For another example, based on the sensed engine working conditions, the cylinder head can be automatically or manually switched to implement engine brake and/or cylinder deactivation functions.

FIG. 11A is a schematic diagram showing an example control logic 1100 of the ECU. The control logic 1100 can be implemented by software (e.g., executable codes stored in a memory) or hardware (e.g., a specific chip) means. The ECU can take inputs from various sensors and output control signals to actuators or control units to change the engine working conditions. The control logic 1100 can control timings for the intake and/or exhaust tubular systems to obtain a balance between engine output performance, fuel consumption, and emission control. The tube positions for the tubular systems can be fed back using tube position sensors, based on which the ECU can constantly and continuously control the flow areas and the timings.

FIG. 11B is another schematic diagram showing an example controller area network (CAN) of an engine. The CAN includes sensors, an ECU, and actuators or control units for changing engine working conditions. The CAN can be used for engine control systems (e.g., an under-hood engine management module) connected via a CAN bus. As shown in FIG. 11B, the ECU can determine a target tube timing position based on inputted data from at least one of a tube position sensor, a mass air flow sensor, and a throttle body position sensor. Based on inputted data from at least one of an engine coolant temperature sensor, a transmission/gear sensor, and an RPM sensor, the ECU can calculate corrections to be applied to the determined target tube timing position and determine a corrected tube timing position. The ECU can further detect an actual tube timing position based on inputted data from at least one tube position sensor. Based on the difference between the actual tube timing position and the corrected tube timing position, the ECU can send control signals to adjust the tube timing position, such as via a hydraulic or electric valve. In some implementations, duty-wide control signals can also be integrated into the control signals sent by the ECU to change the engine working conditions.

It should be noted that FIGS. 11A-11B only show example control logic for the cylinder head, and variations, modifications, and other implementations are also possible.

The target flow areas and the target timing positions can be calibrated using designed working conditions (e.g., sample RPMs, loadings, torques, or throttle body positions) and stored in the ECU. The calibration can generate map data between the corresponding working conditions, the target flow areas, and the target timing positions.

Table A shows an example calibrated control map between target timing positions and their corresponding working conditions. The values of the calibrated control map can be optimized for fuel efficiency. It should be noted that all values in Table A are examples only.

Actual values of the parameters in Table A can be optimized according to real engine working conditions.

TABLE A
Target Timings

| | Intake | Exhaust |
|---|---|---|
| Open | BTDC 38 | BBDC 55 |
| Close | ABDC 76 | ATDC 40 |
| Starting Flow Area | 50% | 50% |
| Low RPM | 50% | 50% |
| Idle RPM with | 50% of Inner Chamber | 50% of Inner Chamber |
| Smallest Flow Areas | Port Areas | Port Areas |
| Medium RPM | 60% of Inner Chamber | EGR of Inner Chamber |
| | Port Areas | Port Areas |
| Maximum Torque | 70% of Inner Chamber | EGR of Inner Chamber |
| | Port Areas | Port Areas |
| Maximum Power | 80% of Inner Chamber | EGR of Inner Chamber |
| | Port Areas | Port Areas |
| Maximum RPM | 90% of Inner Chamber | EGR of Inner Chamber |
| | Port Areas | Port Areas |
| Atkinson/Miller Cycle | BTDC 0 | BBDC 55 |
| | ABDC 76 | ATDC 60 |

FIG. 12 is an example diagram of valve timing delay characteristic curves for a cylinder using the disclosed cylinder head. The y-axis represents the valve lift or the flow areas, and the x-axis represents crank angles. Curves 1202-1206 are valve timing delay characteristic curves for the exhaust, and curves 1208-1212 are valve timing delay characteristic curves for the intake. A region 1214 represent the valve overlap angle between the exhaust and the intake. When the engine is started, it can be working in the Otto cycle, in which the valve timing delay characteristic curve for the exhaust is the curve 1202, and the valve timing delay characteristic curve for the intake is the curve 1208. After the engine is started, the valve timing can be continuously delayed for switching the engine to work in the Atkinson/Miller cycle. For example, the exhaust valve timing can be adjusted such that the valve timing delay characteristic curve for the exhaust can move from the curve 1202 to 1204 to 1206 for delaying exhaust valve opening timing, in which the power stroke can be prolonged. The intake valve timing can be adjusted such that the valve timing delay characteristic curve for the intake can move from the curve 1208 to 1210 to 1212 for delaying intake valve opening timing, in which the compression stroke can be prolonged. It should be noted that the curves 1202 and 1208 moves continuously, and curves 1204, 1206, 1210, and 1212 are example curves showing intermediate positions of the moving curves. The movement of the curves can stop and stay when a full Atkinson/Miller cycle is achieved for the engine.

The implementations herein can be described in terms of functional block components and various processing steps. The disclosed processes and sequences can be performed alone or in any combination. Functional blocks can be realized by any number of hardware and/or software components that perform the specified functions. For example, the described implementations can employ various integrated circuit components (e.g., memory elements, processing elements, logic elements, look-up tables, and the like), which can carry out a variety of functions under the control of one or more microprocessors or other control devices. Similarly, where the elements of the described implementations are implemented using software programming or software elements, the disclosure can be implemented with any programming or scripting languages, with the various algorithms being implemented with any combination of data structures, objects, processes, routines, or other programming elements. Functional aspects can be implemented in algorithms that execute on one or more processors. Furthermore, the implementations of the disclosure could employ any number of conventional techniques for electronics configuration, signal processing and/or control, data processing, and the like. The steps of all methods described herein can be performed in any suitable order unless otherwise indicated herein or otherwise clearly indicated by the context.

In this disclosure, the terms “signal,” “data,” and “information” are used interchangeably. The use of “including” or “having” and variations thereof herein is meant to encompass the items listed thereafter and equivalents thereof as well as additional items. Unless specified or limited otherwise, the terms “mounted,” “connected,” “supported,” “coupled,” and variations thereof are used broadly and encompass both direct and indirect mountings, connections, supports, and couplings. Further, “connected” and “coupled” are not restricted to physical or mechanical connections or couplings.

The term “example” is used herein to mean serving as an example, instance, or illustration. Any aspect or design described herein as “example” is not necessarily to be construed as being preferred or advantageous over other aspects or designs. Rather, use of the word “example” is intended to present concepts in a concrete fashion.

In addition, the articles “a” and “an” as used in this disclosure and the appended claims should generally be construed to mean “one or more” unless specified otherwise or clear from the context to be directed to a singular form. Moreover, use of the term “an aspect” or “one aspect” throughout this disclosure is not intended to mean the same implementation or aspect unless described as such. Furthermore, recitation of ranges of values herein is merely intended to serve as a shorthand method of referring individually to each separate value falling within the range, unless otherwise indicated herein, and each separate value is incorporated into the specification as if it were individually recited herein.

As used in this disclosure, the term “or” is intended to mean an inclusive “or” rather than an exclusive “or” for the two or more elements it conjoins. That is, unless specified otherwise, or clearly indicated otherwise by the context, “X includes A or B” is intended to mean any of the natural inclusive permutations thereof. In other words, if X includes A; X includes B; or X includes both A and B, then “X includes A or B” is satisfied under any of the foregoing instances. The term “and/or” as used in this disclosure is intended to mean an “and” or an inclusive “or.” That is, unless specified otherwise, or clearly indicated otherwise by the context, “X includes A, B, and/or C” is intended to mean X can include any combinations of A, B, and C. In other words, if X includes A; X includes B; X includes C; X includes both A and B; X includes both B and C; X includes both A and C; or X includes all of A, B, and C, then “X includes A and/or B” is satisfied under any of the foregoing instances. Similarly, “X includes at least one of A, B, and C” is intended to be used as an equivalent of “X includes A, B, and/or C.”

The aspects shown and described herein are illustrative examples of the disclosure and are not intended to otherwise limit the scope of the disclosure in any way. For the sake of brevity, conventional electronics, control systems, software development, and other functional aspects of the systems (and components of the individual operating components of the systems) cannot be described in detail herein. Furthermore, the connecting lines or connectors shown in the various figures presented are intended to represent exemplary functional relationships and/or physical or logical couplings between the various elements. Many alternative or additional functional relationships, physical connections, or logical connections can be present in a practical device.

While this disclosure has been described with reference to certain embodiments, it is to be understood that the disclosure is not to be limited to the disclosed embodiments but, on the contrary, is intended to cover various modifications and equivalent arrangements included within the scope of the appended claims, which scope is to be accorded the broadest interpretation as is permitted under the law so as to encompass all such modifications and equivalent arrangements.

What is claimed is:

1. An apparatus for intake and exhaust of an engine, comprising:
an outer tube comprising an outer-tube close end, an outer-tube open end, and a first outer-tube aperture set comprising a first aperture and a first outer-tube aperture group comprising at least one aperture;
an inner tube concentrically positioned in the outer tube having a concentric line, comprising an inner-tube close end, an inner-tube open end, and a first inner-tube aperture set comprising a second aperture and a first inner-tube aperture group comprising at least one aperture, wherein the inner-tube close end is proximate to the outer-tube close end; and
a shaft connected to the inner-tube open end for rotating the inner tube in the outer tube about the concentric line, wherein, when the inner tube rotates, the second aperture sweeps across a portion of the first aperture, and the first inner-tube aperture group sweeps across a portion of the first outer-tube aperture group.

2. The apparatus of claim 1, wherein intake air moves into the inner tube when the first inner-tube aperture group sweeps across the portion of the first outer-tube aperture group, and the intake air moves into a combustion chamber of the engine when the second aperture sweeps across the portion of the first aperture.

3. The apparatus of claim 1, wherein exhaust moves into the inner tube from a combustion chamber of the engine when the second aperture sweeps across the portion of the first aperture, and the exhaust moves out of the inner tube when the first inner-tube aperture group sweeps across the portion of the first outer-tube aperture group.

4. The apparatus of claim 1, further comprising:
a second outer-tube aperture set provided with the outer tube, comprising a third aperture and a second outer-tube aperture group;
a second inner-tube aperture set provided with the inner tube, comprising a fourth aperture and a second inner-tube aperture group; and
a separator, provided between the first inner-tube aperture group and the second inner-tube aperture group.

5. The apparatus of claim 4, wherein the separator further comprises turbines, a base plate, and a side wall extending against an inner side wall of the inner tube, wherein
the side wall comprises an opening mating with one of the second aperture and the fourth aperture, and
the turbines are fixed on at least one of the base plate and the side wall.

6. The apparatus of claim 1, further comprising:
a wave spring, provided between the outer-tube close end and the inner-tube close end;
a chamber separator, provided at the inner-tube open end in the inner tube;
an oil chamber, enclosed by the chamber separator, the shaft, and an inner side wall of the inner tube; and
an aperture provided with the shaft, connected to the oil chamber, wherein the wave spring and the oil chamber are used for driving the outer tube to move along the concentric line.

7. The apparatus of claim 1, further comprising:
a tube gear, provided at the inner-tube open end in the inner tube; and
a shaft gear, provided at an end of the shaft in the outer tube, wherein the shaft gear slidingly engages with the tube gear.

8. The apparatus of claim 7, wherein the tube gear comprises an internal gear and the shaft gear comprises an external gear; or
the tube gear comprises the external gear and the shaft gear comprises the internal gear.

9. The apparatus of claim 7, wherein the tube gear comprises an internal gear, and the shaft gear comprises an external gear.

10. The apparatus of claim 1, further comprising:
a driving gear provided on an outer wall of the outer-tube close end, for rotating the outer tube about the concentric line.

11. The apparatus of claim 1, further comprising:
a seal groove, provided between an outer side wall of the inner tube and an inner side wall of the outer tube.

12. A cylinder head for an engine, comprising:
a cylinder head body, comprising:
a tubular cavity;
a manifold port provided on the tubular cavity, connecting to a manifold of the engine; and
a chamber port provided on the tubular cavity, connecting to a combustion chamber of the engine; and
a tubular assembly, comprising:
an outer tube positioned in the tubular cavity, comprising an outer-tube close end, an outer-tube open end, and a first outer-tube aperture set comprising a first aperture and a first outer-tube aperture group comprising at least one aperture;
an inner tube positioned in the outer tube, comprising an inner-tube close end, an inner-tube open end, and a first inner-tube aperture set comprising a second aperture and a first inner-tube aperture group comprising at least one aperture, wherein the inner-tube close end is proximate to the outer-tube close end; and
a shaft connected to the inner-tube open end for rotating the inner tube in the outer tube, wherein
the first aperture overlaps with a portion of the chamber port;
the first outer-tube aperture group overlaps with a portion of the manifold port; and
when the inner tube rotates, the second aperture sweeps across a portion of the first aperture and the first inner-tube aperture group sweeps across a portion of the first outer-tube aperture group.

13. The cylinder head of claim 12, wherein the cylinder head body further comprises:
an upper body, comprising the manifold port and an upper semicircular trough; and
a lower body, comprising the chamber port and a lower semicircular trough, wherein the upper body is fixedly connected to the lower body, and the upper semicircular trough and the lower semicircular trough form the tubular cavity.

14. The cylinder head of claim 12, wherein the cylinder head body comprises:
an intake tubular cavity;
an intake manifold port provided on the intake tubular cavity, connecting to an intake manifold of the engine;
a chamber inlet port provided on the intake tubular cavity, connecting to the combustion chamber;
an exhaust tubular cavity;
an exhaust manifold port provided on the exhaust tubular cavity, connecting to an exhaust manifold of the engine; and
a chamber outlet port provided on the exhaust tubular cavity, connecting to the combustion chamber.

15. The cylinder head of claim 14, wherein the tubular assembly comprises:
an intake tubular assembly, comprising:
an intake outer tube positioned in the intake tubular cavity, comprising an intake outer-tube close end, an intake outer-tube open end, an intake aperture overlapping with a portion of the chamber inlet port, and an intake outer-tube aperture group overlapping with a portion of the intake manifold port;
an intake inner tube positioned in the intake outer tube, comprising an intake inner-tube close end, an intake inner-tube open end, and an intake inner-tube aperture group, wherein the intake inner-tube close end is proximate to the intake outer-tube close end; and
an intake shaft connected to the intake inner-tube open end for rotating the intake inner tube in the intake outer tube; and
an exhaust tubular assembly, comprising:
an exhaust outer tube positioned in the exhaust tubular cavity, comprising an exhaust outer-tube close end, an exhaust outer-tube open end, an exhaust aperture overlapping with a portion of the chamber outlet port, and an exhaust outer-tube aperture group overlapping with a portion of the exhaust manifold port;
an exhaust inner tube positioned in the exhaust outer tube, comprising an exhaust inner-tube close end, an exhaust inner-tube open end, and an exhaust inner-tube aperture group, wherein the exhaust inner-tube close end is proximate to the exhaust outer-tube close end; and
an exhaust shaft connected to the exhaust inner-tube open end for rotating the exhaust inner tube in the exhaust outer tube.

16. The cylinder head of claim 12, wherein the cylinder head body comprises:
an intake manifold port provided on the tubular cavity, connecting to an intake manifold of the engine;
an exhaust manifold port provided on the tubular cavity, connecting to an exhaust manifold of the engine;
a chamber inlet port provided on the tubular cavity, connecting to the combustion chamber; and
a chamber outlet port provided on the tubular cavity, connecting to the combustion chamber.

17. The cylinder head of claim 16, wherein the chamber inlet port and the chamber outlet port are diagonally arranged on the combustion chamber.

18. The cylinder head of claim 16, wherein the tubular assembly further comprises:
a second outer-tube aperture set provided on the outer tube, comprising a third aperture overlapping with a portion of the chamber outlet port and a second outer-tube aperture group overlapping with a portion of the exhaust manifold port, wherein the first aperture overlaps with a portion of the chamber inlet port, and the first outer-tube aperture group overlaps with a portion of the intake manifold port; and
a second inner-tube aperture set provided on the inner tube, comprising a fourth aperture and a second inner-tube aperture group, wherein when the inner tube rotates, the fourth aperture sweeps across a portion of the third aperture and the second inner-tube aperture group sweeps across a portion of the second outer-tube aperture group.

19. The cylinder head of claim 12, wherein the first aperture has no overlap with the chamber port.

20. The cylinder head of claim 12, further comprising:
a seal groove, provided between an outer side wall of the outer tube and an inner side wall of the tubular cavity.
